(19) United States
(12) Patent Application Publication
(10) Pub. No.: US 2026/0361884 A1
(43) Pub. Date: Nov. 12, 2026

(54) ENCODING AND DECODING METHODS, AND DECODER

(71) Applicant: GUANGDONG OPPO MOBILE TELECOMMUNICATIONS CORP., LTD., Dongguan (CN)

(72) Inventor: Honglian WEI, Dongguan (CN)

(21) Appl. No.: 19/733,099

(22) Filed: Jul. 7, 2026

Related U.S. Application Data
(63) Continuation of application No. PCT/CN2024/072194, filed on Jan. 12, 2024.

(51) Int. Cl. H04N 19/137; H04N 19/159; H04N 19/17; H04N 19/70

(52) U.S. Cl. CPC H04N 19/137; H04N 19/159; H04N 19/17; H04N 19/70

(57) ABSTRACT

A decoding method includes the following. A bitstream is parsed to determine first syntax information corresponding to a vertex in a current group. The first syntax information indicates whether a motion vector corresponding to at least one coordinate dimension for the vertex in the current group is inferred to be a preset value. Motion-vector decoded information corresponding to the vertex in the current group is determined based on the first syntax information.

### CROSS-REFERENCE TO RELATED APPLICATION(S)

This application is a continuation of International Application No. PCT/CN2024/072194, filed Jan. 12, 2024, the entire disclosure of which is incorporated herein by reference.

### TECHNICAL FIELD

Embodiments of the disclosure relate to the field of dynamic mesh decoding and encoding technologies, and in particular, to encoding and decoding methods, and a decoder.

### BACKGROUND

In a standard reference software for dynamic mesh coding (DMC) provided by a moving picture experts group (MPEG), when inter encoding is performed on a base mesh of a current picture, motion vectors of vertices in the base mesh are usually encoded. At a decoder end, by decoding the motion vectors of the vertices in the base mesh, in combination with connectivity information of a base mesh of a reference picture corresponding to the current picture, a base mesh corresponding to the current picture is reconstructed.

However, current methods for determining an encoding and decoding mode for a motion vector is not yet perfect, resulting in a high encoding and decoding cost for the motion vector, thereby reducing an encoding and decoding efficiency of the base mesh and consequently decreasing an encoding and decoding performance of DMC.

### SUMMARY

In a first aspect, a decoding method applied to a decoder is provided in embodiments of the disclosure. The method includes the following. A bitstream is parsed to determine first syntax information corresponding to a vertex in a current group. The first syntax information indicates whether a motion vector corresponding to at least one coordinate dimension for the vertex in the current group is deferred to be a preset value. Motion-vector decoded information corresponding to the vertex in the current group is determined based on the first syntax information.

In a second aspect, an encoding method applied to an encoder is provided in embodiments of the disclosure. The method includes the following. A motion vector corresponding to each coordinate dimension in at least one coordinate dimension for a vertex in a current group is determined. When inter encoding is performed on the current group, encoding cost estimation is performed separately for a skipping-encoding mode and for at least one prediction mode on the motion vector corresponding to each coordinate dimension for the vertex current group, to determine a first encoding cost corresponding to each coordinate dimension and at least one second encoding cost corresponding to each coordinate dimension. The first encoding cost corresponds to the skipping-encoding mode. The at least one second encoding cost corresponds to the at least one prediction mode. First syntax information is determined according to the first encoding cost corresponding to each coordinate dimension and the at least one second encoding cost corresponding to each coordinate dimension. The first syntax information indicates whether the motion vector corresponding to the at least one coordinate dimension for the vertex in the current group is deferred to be a preset value.

In a third aspect, a decoder is provided in embodiments of the disclosure. The decoder includes a memory and a processor. The memory is configured to store computer programs which, when executed by a processor, cause the processor to implement the decoding method in the first aspect.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiments described herein.

### BRIEF DESCRIPTION OF THE DRAWINGS

FIG. 1A is a first schematic diagram of a three-dimensional mesh picture.

FIG. 1B is a partially enlarged schematic diagram of a three-dimensional mesh picture.

FIG. 2 is a schematic diagram illustrating a connection of a three-dimensional mesh.

FIG. 3A is a second schematic diagram of a three-dimensional mesh picture.

FIG. 3B is a schematic diagram of a storage format of mesh data.

FIG. 3C is a schematic diagram of attributes of a three-dimensional mesh picture.

FIG. 4 is a schematic diagram of a composition of an overall mesh coding framework.

FIG. 5A is a schematic diagram illustrating preprocessing of a two-dimensional curve.

FIG. 5B is a schematic diagram illustrating generation of displacement coefficients.

FIG. 6A is a first schematic diagram illustrating quantization of mesh geometric position information.

FIG. 6B is a second schematic diagram illustrating quantization of mesh geometric position information.

FIG. 7A is a schematic diagram illustrating encoding of connectivity of triangular faces.

FIG. 7B is a schematic diagram illustrating encoding of geometric position information.

FIG. 7C is a schematic diagram illustrating encoding of texture coordinates.

FIG. 8 is a schematic diagram illustrating a basic principle of displacement coefficients.

FIG. 9 is a schematic diagram illustrating encoding of displacement coefficients mapped to a two-dimensional picture.

FIG. 10 is a schematic diagram illustrating encoding of inter geometric position information.

FIG. 11A is a schematic diagram of a composition of an intra encoding framework.

FIG. 11B is a schematic diagram of a composition of an inter encoding framework.

FIG. 12A is a schematic diagram of a composition of an intra decoding framework.

FIG. 12B is a schematic diagram of a composition of an inter decoding framework.

FIG. 13 is a schematic diagram of a network architecture for encoding and decoding according to embodiments of the disclosure.

FIG. 14 is a schematic flow chart of an encoding method according to embodiments of the disclosure.

FIG. 15 is a schematic flow chart of a decoding method according to embodiments of the disclosure.

FIG. 16 is a schematic diagram of a composition structure of an encoder according to embodiments of the disclosure.

FIG. 17 is a schematic diagram of a specific hardware structure of an encoder according to embodiments of the disclosure.

FIG. 18 is a schematic diagram of a composition structure of a decoder according to embodiments of the disclosure.

FIG. 19 is a schematic diagram of a specific hardware structure of a decoder according to embodiments of the disclosure.

FIG. 20 is a schematic diagram of a composition structure of an encoding and decoding system according to embodiments of the disclosure.

### DETAILED DESCRIPTION

In order for better understanding of the features and technical contents of embodiments of the disclosure, the implementation of embodiments of the disclosure will be described in detail below with reference to the accompanying drawings. The accompanying drawings herein are merely intended for illustration rather than limitation of embodiments of the disclosure.

Unless otherwise defined, all technical and scientific terms used herein have the same meaning as commonly understood by one of ordinary skill in the art to which this disclosure belongs. The terms used herein are only for the purpose of describing embodiments of the disclosure and are not intended to limit the disclosure.

In the following description, reference is made to “some embodiments”, which describe a subset of all possible embodiments, but it is understood that “some embodiments” may be the same subset or different subsets of all possible embodiments and may be combined with each other without conflict.

It can also be noted that, the terms “first/second/third” involved in embodiments of the disclosure are only used to distinguish similar objects and do not represent a specific ordering of objects. It can be understood that, the “first/second/third” may be interchanged to a specific order or sequence where permitted, so that embodiments of the disclosure described herein can be implemented in an order other than those illustrated or described herein.

It can be noted that, decoding and synthesizing bitstreams in different data formats may be allowed in the same video scene. The data formats may include at least a picture format, a point cloud format, and a mesh format. In this way, real-time immersive video interactive services can be provided for multiple data formats (e.g., mesh, point cloud, picture, etc.) from different sources.

In embodiments of the disclosure, a data format-based method may allow independent processing at a bitstream level of the data format. That is, like tiles or slices in video coding, different data formats in the scenario can be encoded independently, so that independent encoding and decoding can be performed based on the data format.

Generally speaking, a keyframe-based representation method is used for three-dimensional animation content, that is, each frame is a static mesh. Static meshes at different times have the same topology and different geometric structures. However, the data volume of three-dimensional dynamic meshes based on keyframe representation is particularly large. Therefore, the challenges of effective storage, transmission, and rendering have become obstacles for the development of three-dimensional dynamic meshes. In addition, for different user terminals (computers, notebooks, portable devices, mobile phones), spatial scalability of the mesh needs to be supported; for different mesh bandwidths (broadband, narrowband, wireless), quality scalability of the mesh needs to be supported. Therefore, compression of the three-dimensional dynamic mesh is a very critical issue.

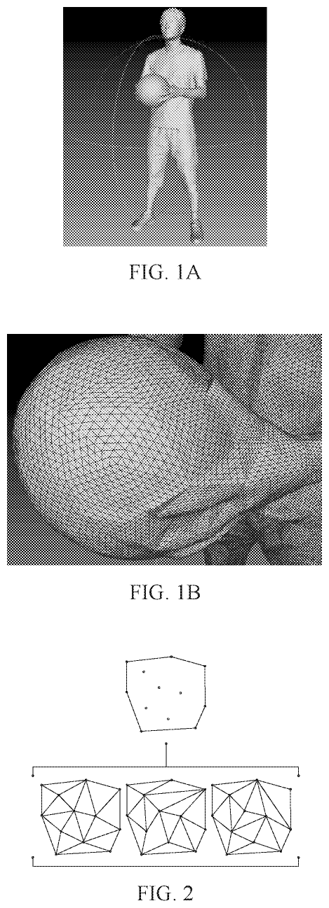

A three-dimensional mesh is a three-dimensional object surface composed of countless polygons in space. Polygons are composed of vertices and edges. FIG. 1A illustrates a three-dimensional mesh picture, and FIG. 1B illustrates a partially enlarged schematic diagram of the three-dimensional mesh picture. As can be seen from FIG. 1A and FIG. 1B, the mesh surface is composed of closed polygons.

In a two-dimensional picture, each pixel has information expression, and the distribution is regular, so there is no need to additionally record position information of pixels. However, in a three-dimensional mesh, the distribution of vertices in three-dimensional space is random and irregular, and the composition of polygons needs to be additionally specified. Therefore, it is necessary to record a position of each vertex in space and connectivity information of each polygon to fully express a mesh picture. As illustrated in FIG. 2, with the same number of vertices and the same vertex positions, formed surfaces are completely different due to different connectivity.

In addition to the above information, since three-dimensional mesh pictures are usually encoded using existing two-dimensional picture/video coding methods, it is necessary to convert the three-dimensional mesh from three-dimensional space to a two-dimensional picture. UV coordinates define this conversion process.

Similar to two-dimensional pictures, each position in an acquisition process may have corresponding attribute information, usually RGB color values, which reflect the color of the object. For three-dimensional meshes, in addition to colors, the attribute information corresponding to each vertex usually includes a reflectance value, which reflects a surface material of the object. The attribute information of the three-dimensional mesh is stored through a two-dimensional picture, and a mapping from two dimensions to three dimensions is specified by UV coordinates.

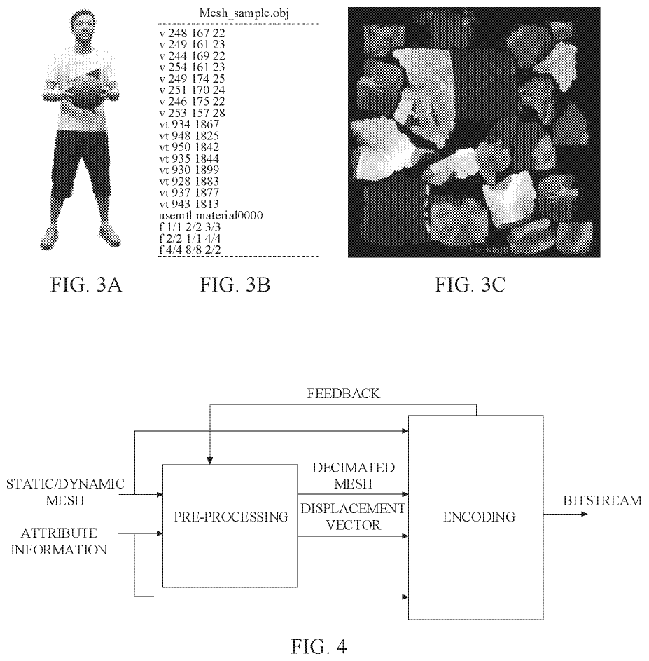

Therefore, three-dimensional mesh data usually includes three-dimensional geometric position information (x, y, z), geometric connectivity, UV coordinates, and attribute maps. FIG. 3A is a three-dimensional mesh picture. FIG. 3B illustrates a storage format of mesh data, which includes three-dimensional geometric position information, UV coordinates, and connectivity information. FIG. 3C is a schematic diagram of corresponding attributes.

Current three-dimensional dynamic mesh compression methods include space-time prediction-based methods, which improve a compression efficiency by eliminating spatial and temporal correlations; principal components analysis (PCA)-based techniques, which project in an eigenvector space to concentrate energy; and wavelet-based methods, which support spatial scalability and quality scalability.

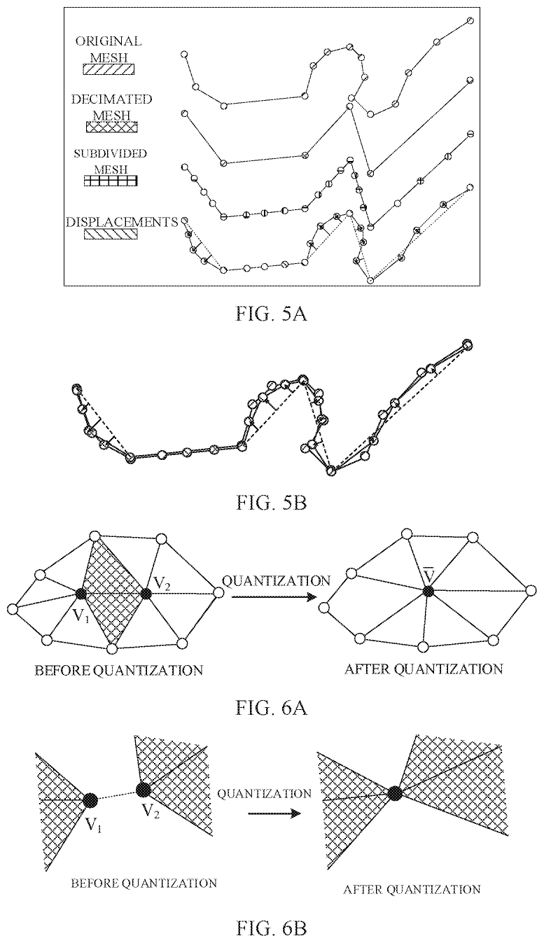

It can be noted that, in the dynamic mesh coding (DMC) provided by the moving picture experts group (MPEG), FIG. 4 is a schematic diagram of an overall mesh coding framework, FIG. 5A is a schematic diagram illustrating preprocessing of a two-dimensional curve, and FIG. 5B is a schematic diagram illustrating generation of displacement coefficients. The pre-processing of a three-dimensional mesh can be analogized similarly. At an encoding end, two parts are mainly involved: the pre-processing and an encoder. First, a base mesh and displacement coefficients are generated through pre-processing. The pre-processing includes the following. First, an original mesh is downsampled to generate a decimated mesh with a greatly reduced number of vertices, or referred to as the base mesh. Then, the base mesh is subdivided, and new vertices are generated through an algorithm and inserted on the edges of the base mesh to obtain a subdivided mesh. Finally, for each vertex in the subdivided mesh, a vertex nearest to that vertex is found in the original mesh; a vector between the vertex in the subdivided mesh and the nearest vertex in the original mesh is referred to as the displacement coefficient. Since the subdivided mesh can be automatically generated at encoding and decoding ends as long as a subdivision algorithm and the number of subdivision iterations are determined, after pre-processing, the original mesh only needs to be represented as a simple base mesh and a series of displacement coefficients, which can greatly reduce the amount of data without affecting reconstruction at a decoding end.

Video-based dynamic mesh coding (V-DMC) mainly involves geometric position information coding and attribute information coding. Exemplarily, each frame file of a sequence basketball_player includes two files: basketball_player_fr0001_qp12_qt12.obj and basketball_player_fr0002.png. In the files, basketball_player_fr0001_qp12_qt12.obj contains four types of information: geometric position information (x, y, z), connectivity of triangular faces for geometric position information, texture coordinates (u, v), and connectivity of texture coordinates; basketball_player_fr0002.png represents texture attribute information of the current picture. In a current V-DMC encoder, geometric position information is jointly encoded using a dynamic range arithmetic coding (DRACO) encoder and a video encoder (Video Codec), and texture information is directly encoded using the Video Codec. The Video Codec may include H.264/advanced video coding (AVC), H.265/high efficiency video coding (HEVC), H.266/versatile video coding (VVC/VV-enC), etc. In the following, coding of mesh geometric information will be introduced in detail.

The coding of geometric information can be divided into: coding of position information (geometric position information and texture position information) and coding of connectivity (connectivity of triangular faces for geometric position information, connectivity for texture position information). Current V-DMC mainly has two encoding test conditions: intra coding and inter coding (low delay, currently no random access (RA) test environment).

### (I) Intra Coding for Geometric Information.

### 1. Mesh Pre-Processing.

a) As illustrated in FIG. 5A and FIG. 5B, two-dimensional connectivity is taken as an example. Connectivity of the original mesh contains a large number of points. Before encoding the mesh geometric information, quantization or simplification of the mesh geometric information is first performed, and finally a corresponding decimated mesh is obtained as a base mesh.

b) As illustrated in FIG. 6A and FIG. 6B, quantization of the mesh is performed based on triangular face coordinates. According to connectivity between quantized points, the quantization involves the following two cases:

If two vertices share an edge, i.e., two vertices belonging to one edge before quantization, then after quantization, all triangular faces connected to the two vertices need to be connected together. As illustrated in FIG. 6A, previous triangular faces disappear.

Otherwise, if two vertices do not share an edge, i.e., two vertices not belonging to one edge, then after quantization, only boundaries of the two vertices need to be merged. As illustrated in FIG. 6B, the number of triangular faces does not change.

c) Throughout the quantization of the mesh based on triangular face coordinates, the core issue is how to obtain the best vertices based on the previous vertex coordinates. Currently, in V-DMC, the best quantized point is obtained among the following four modes. Assuming vertex distribution before quantization is V1 and V2, and vertex coordinates after quantization are V′, the following exists: V1, V2, (V1+V2)/2, and Q−1 (V1+V2), where Q is a quantization matrix corresponding to vertex coordinates of V1 and V2. Finally, an optimal quantized point is selected based on a distortion measure D for quantization.

### 2. Base Mesh Coding.

a) After obtaining the base mesh, the DRACO encoder is used to encode the geometric information of the base mesh. The geometric information mainly includes: geometric position information and connectivity of geometric position information. An entire DRACO procedure is as follows. First, coding of connectivity is completed, then the geometric position information of points is encoded based on the connectivity of geometric positions, and finally, texture position information is encoded based on the connectivity and the geometric position information.

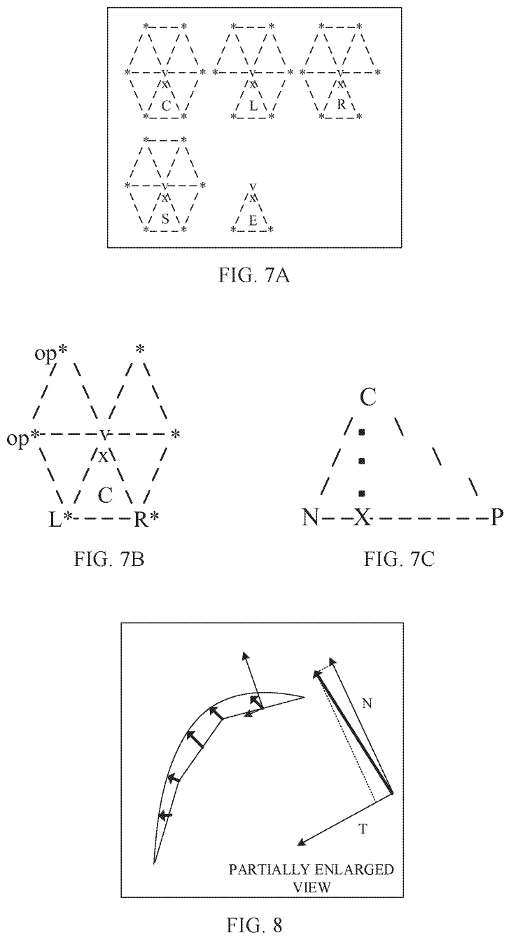

b) Coding of connectivity. DRACO adopts an “edge breaker coding” scheme for encoding the mesh connectivity. Reference can be made to FIG. 7A. In FIG. 7A, v represents a current vertex. Before encoding the mesh connectivity, vertices of the mesh are divided into five types: C, L, R, S, and E. The physical meaning of each symbol is as follows.

C: None of the triangular faces connected to the current vertex have been encoded.

L: A triangular face to the left of the current vertex has been encoded.

R: A triangular face to the right of the current vertex has been encoded.

S: Neither the left nor the right triangular face connected to the current vertex has been encoded.

E: Both the left and right triangular faces connected to the current vertex have been encoded.

Finally, according to a certain order, a type of each vertex and a processing order for the vertices are encoded. The decoding end restores the geometric connectivity of the mesh according to the processing order of the vertices and the vertex type.

c) Coding of geometric position information. After completing the coding of vertex connectivity, predictive encoding of the geometric position information of each vertex is performed based on the vertex connectivity. The predictive encoding adopts “parallelograms algorithm”, as specifically illustrated in FIG. 7B. Simple linear fitting is performed using three adjacent vertices of a current vertex to-be-encoded: the left vertex, the right vertex, and the opposite vertex:

predₚₒₛ=(left+right)−opposite (1)

d) After completing the coding of the vertex connectivity and geometric position information, based on the decoding and reconstruction of these two information, predictive encoding of texture coordinates is performed, as specifically illustrated in FIG. 7C. Similarly, assuming the current vertex is C, the left and right vertices of the current vertex can be obtained according to the vertex connectivity. Then, the texture coordinates of the left and right vertices are used to perform predictive encoding on the texture coordinates of the current vertex C.

### 3. Coding of Displacement Coefficient.

a) Firstly, after completing the encoding and reconstruction of the base mesh, a certain partitioning algorithm is used to partition the base mesh to obtain an initially reconstructed mesh. Specifically, as illustrated in a curve corresponding to the subdivided mesh in FIG. 5A, by using simple linear interpolation, the subdivided mesh (also referred to as an “initial mesh”) is obtained. Coordinates of newly inserted point are obtained by linear interpolation based on two vertices on a current boundary:

$${pos}_{new} = \frac{( {pos}_{1} + {pos}_{2} )}{2} \qquad ( 2 )$$

b) Secondly, an error Delta between vertices in the subdivided mesh after partitioning and the original mesh is calculated. The error Delta can be a point error in a world coordinate system. Finally, Displacement (i.e., displacement coefficient) of each vertex is calculated using an error Delta of each vertex and a normal vector Norm of each vertex, as specifically illustrated in FIG. 8. In FIG. 8, bold solid lines represent the error Delta, and N and T represent the normal vector Norm. In this case, the specific calculation method is as follows:

Displacement=Delta×Norm (3)

c) After calculating the Displacement for each vertex, a lifting transform can be used to transform residual coefficients from a spatial domain into a frequency domain, thus obtaining corresponding frequency domain residual coefficients.

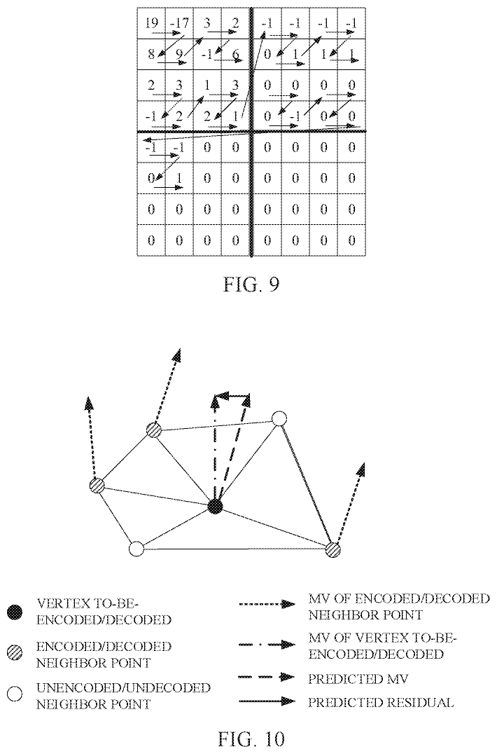

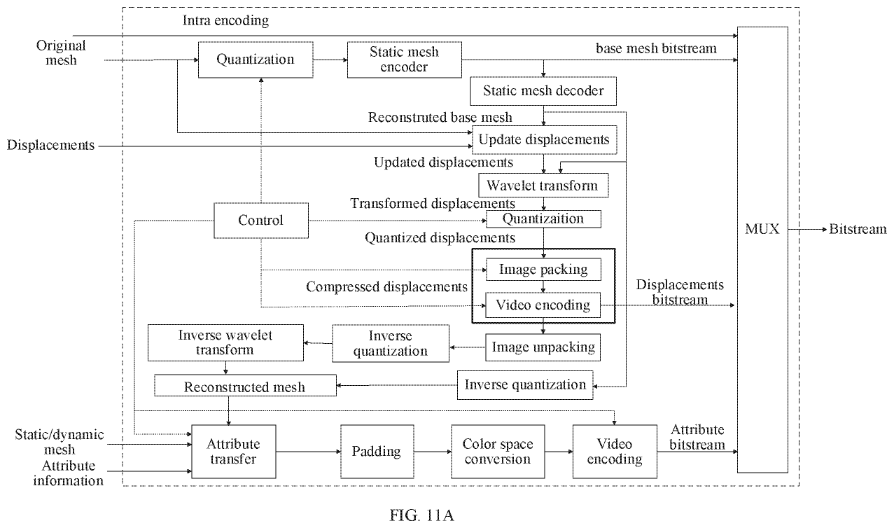

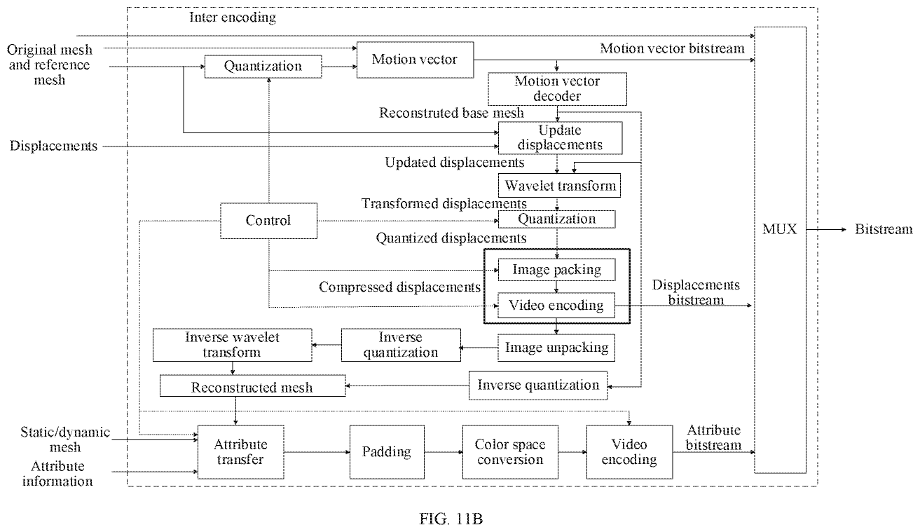

d) Finally, a coefficient packing algorithm is used to map the frequency domain residual coefficients of each vertex onto a two-dimensional picture in a certain order. In the current V-DMC, a Morton code order is used for arrangement, as specifically illustrated in FIG. 9.

e) Finally, a conventional Video Codec is used to encode the two-dimensional picture.

### 4. Recoloring.

Recoloring is an algorithm at the encoding end. After completing the reconstruction of geometric information at the encoding end, original geometric information, original texture attribute information, and reconstructed mesh geometric information are used to recolor the texture attribute information of the reconstructed mesh.

### (II) Inter Coding for Geometric Information.

a) Similar to the above coding, coding of geometric information includes coding of geometric connectivity and geometric position information. However, it can be noted herein that for inter coding of geometric position information, only the geometric position information (x, y, z) of the current base mesh needs to be encoded, and connectivity and texture position information (u, v) do not need to be encoded. The specific reason is that if the current picture can be inter-coded, then at the encoding end, the base mesh of the reference picture of the current picture may be used to obtain mesh information of the current picture. Therefore, the current picture and the reference picture have the same connectivity and uv texture coordinates, with only the geometric position information being different.

b) Based on a), it can be known that only the geometric position information has an error between the current picture and the reference picture. Therefore, the current V-DMC performs predictive encoding on the geometric position information of the current picture.

As specifically illustrated in FIG. 10, a black point is a point to-be-encoded. A prediction point corresponding to a current point in the reference picture (similar to a co-located block in video coding) is used. Then, a motion vector (MV) of the current point is predictively encoded using a neighborhood point of the current point (an MV of an already encoded vertex). Specifically, assuming a coordinate of the current point is pos, and a coordinate of the co-located point is Predₚₒₛ, then the MV of the current point is calculated as:

MV=Pos−Predₚₒₛ (4)

Currently, there are two prediction encoding modes in V-DMC:
i. Directly encoding the MV of the current point;
ii. Predictively encoding the MV of the current point using neighborhood.

At the encoding end, a rate-distortion optimization algorithm is used to obtain the best encoding mode for each coding group (CG). The current V-DMC sets the maximum number of points per CG to 16.

Coding of texture attribute information: Currently, the V-DMC encodes the texture attribute information by directly using a Video Codec, for example: AVC, HEVC, VVC, or VV-enC.

FIG. 11A is a schematic diagram of a framework of an intra encoder. As illustrated in FIG. 11A, in the intra encoder, a common static mesh encoder can be used to encode the base mesh, generating a compressed base mesh bitstream. Next, a reconstructed base mesh is used to update the displacement coefficients (update Displacements). Wavelet transform and quantization are performed on the updated displacement coefficients to obtain displacement coefficients. These are then packed into a picture/video (picture packing, video packing) and encoded using HEVC to generate a compressed displacements bitstream. For attribute map encoding, first, the attribute map is transformed according to the difference between the reconstructed geometric information and the original geometric information (texture transfer), then it is padded (padding), packed (video packing), and encoded with the video encoder to form the compressed attribute bitstream.

FIG. 11B is a schematic diagram of a framework of an inter encoder. As illustrated in FIG. 11B, a flow of the inter encoder is roughly the same as that of the intra encoder, but the inter encoder does not directly encode the base mesh. Instead, the inter encoder encodes the MV between the base mesh of the current picture and the base mesh of the reference picture, and generates a corresponding motion vector bitstream (compressed motion bitstream).

Correspondingly, during the decoding process, the decoder can also be divided into an intra decoder and an inter decoder, according to the different types of frames it processes, which are used to perform intra decoding and inter decoding respectively.

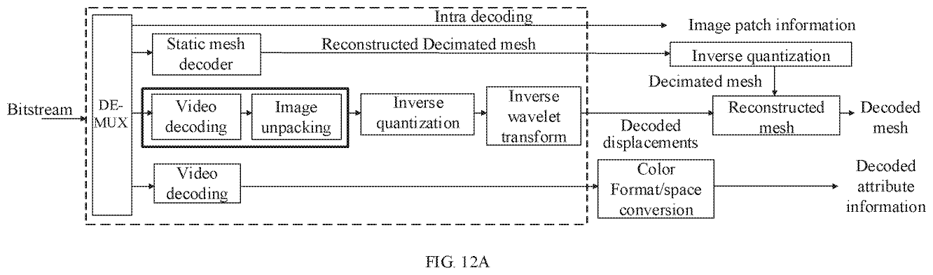

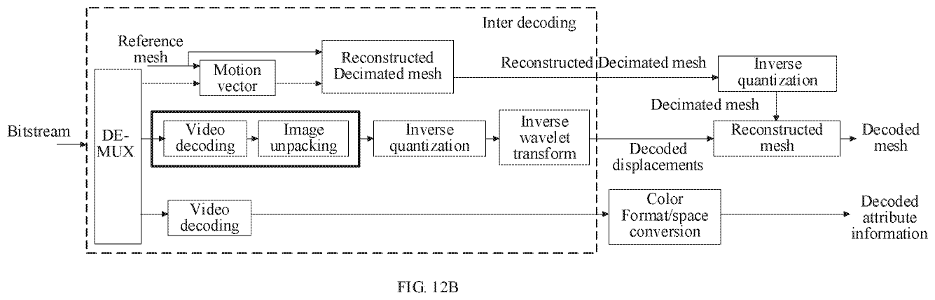

FIG. 12A is a schematic diagram of intra decoding. As illustrated in FIG. 12A, in the intra decoder, a static mesh decoder can be used to decode the base mesh. A video decoder is used to decode a displacement coefficient video, and the displacement coefficients are obtained through video unpacking and inverse wavelet transform. The decoded mesh geometric information is obtained from a decoded base mesh and decoded displacement coefficients. The decoding of the attribute map is directly performed through the video decoder.

FIG. 12B is a schematic diagram of inter decoding. As illustrated in FIG. 12B, the flow of the inter decoder is basically the same as that of the intra decoder. The difference is that the base mesh is not directly decoded; instead, the motion vector is decoded, and the base mesh of the current picture is calculated from the base mesh of the previous picture (e.g., the reference picture).

In summary, currently, in DMC provided by the MPEG, a process of DMC is divided into the following steps. At the encoding end, the quantized base mesh generated by pre-processing is encoded using an open-source DRACO encoder from Google; the displacement coefficients after wavelet transform, quantization, and two-dimensional mapping are encoded using HEVC; the two-dimensional attribute map is also directly fed into an HEVC encoder for encoding. At the decoding end, the base mesh bitstream is decoded by DRACO to generate a decoded base mesh; the displacement coefficient bitstream is decoded by HEVC, subjected to inverse two-dimensional mapping, inverse quantization, and inverse transform to generate decoded displacement coefficients; then the decoded base mesh and decoded displacement coefficients are used together to generate a reconstructed three-dimensional mesh geometry; the attribute bitstream is decoded by HEVC to generate a reconstructed attribute map.

### (III) General Test Conditions of MPEG DMC.

a. There are 2 test conditions in total:
Condition 1: all intra, geometry lossy, attribute lossy;
Condition 2: random access, geometry lossy, attribute lossy.

b. General test sequences can include five categories: Cat1-A, Cat1-B, and Cat1-C, all containing geometric information and color attribute information.

In the related art, when inter coding is performed on a base mesh, a unified coding mode is usually used to encode the motion vectors for vertices in the base mesh on three coordinate dimensions (x, y, z), and a unified coding mode flag indicates an encoding and decoding mode. It can be seen that the inter coding mode of the base mesh in the related art is not yet perfect, thus reducing the coding efficiency of the base mesh. If on each coordinate dimension, the optimal encoding mode for that coordinate dimension can be determined for encoding the motion vector for a vertex in the base mesh, and an independent flag can be used to indicate the encoding mode corresponding to each coordinate dimension, to enable the decoder to use the corresponding decoding mode for decoding, then the coding efficiency of the base mesh can be greatly improved, thereby improving the coding performance of DMC.

On this basis, an encoding and decoding method is provided in embodiments of the disclosure. At the encoding end, the base mesh of the current picture is determined. When inter coding is performed on the base mesh, a motion vector corresponding to each coordinate dimension for a vertex in the base mesh is determined. Based on the motion vector corresponding to each coordinate dimension for the vertex, encoding cost estimation is performed for at least one encoding mode to determine at least one encoding cost for each coordinate dimension. According to the at least one encoding cost, a dimension encoding indicator corresponding to each coordinate dimension for the vertex and motion vector encoding information corresponding to the vertex are determined. The dimension encoding indicator for each coordinate dimension indicates a motion-vector prediction mode corresponding to the coordinate dimension. In this way, for the motion vector of the base mesh on each coordinate dimension, an optimal encoding mode corresponding to the coordinate dimension can be determined by comparing the at least one encoding cost, and a dimension encoding indicator corresponding to each coordinate dimension indicates to the decoder a decoding mode for that coordinate dimension, thereby improving the coding efficiency and further enhancing the coding performance.

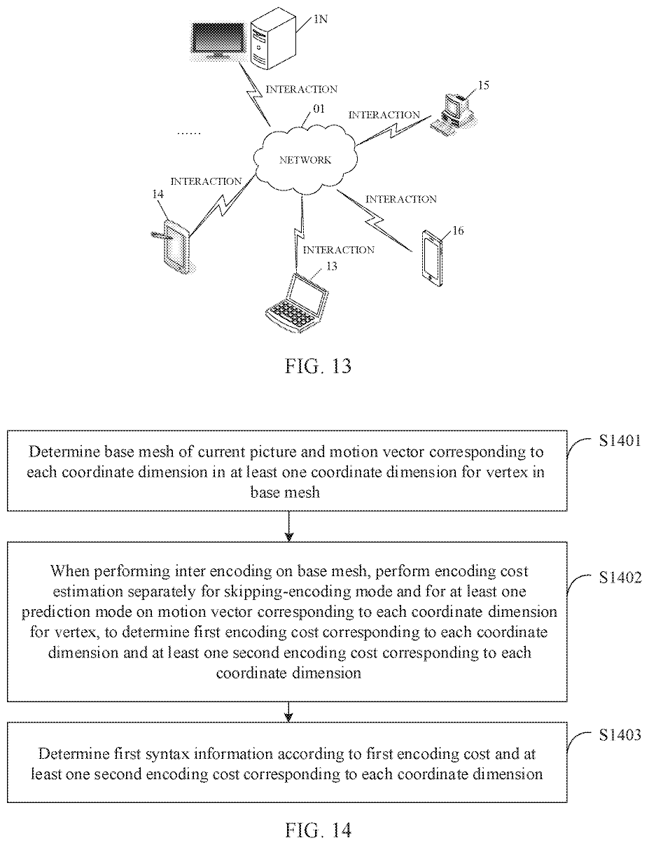

A network architecture of an encoding and decoding system including a decoding method and an encoding method is also provided in embodiments of the disclosure. FIG. 13 is a schematic diagram of a network architecture for encoding and decoding according to embodiments of the disclosure. As illustrated in FIG. 13, the network architecture includes one or more electronic devices 13 to 1N and a communication network 01, where the electronic devices 13 to IN can perform video interaction through the communication network 01. In implementation, the electronic devices can be various types of devices with encoding and decoding functions. For example, the electronic devices may include a mobile phone, a tablet computer, a personal computer, a personal digital assistant, a navigator, a digital phone, a video phone, a television, a sensor device, a server, etc., which are not specifically limited in embodiments of the disclosure. Herein, the decoder or encoder described in embodiments of the disclosure can be the above-mentioned electronic device.

Embodiments of the disclosure will be described in detail below with reference to the accompanying drawings.

In another embodiment of the disclosure, reference can be made to FIG. 14. A first schematic flow chart of an encoding method according to embodiments of the disclosure is illustrated. As illustrated in FIG. 14, the method includes the following.

In S1401, a base mesh of a current picture and a motion vector corresponding to each coordinate dimension for a vertex in the base mesh are determined.

It can be noted that the encoding method of embodiments of the disclosure is applied to an encoder. The encoding method of embodiments of the disclosure may refer to an inter encoding method, and more specifically, may be an inter encoding method for a base mesh in a dynamic mesh. The encoding method can be applied to an encoder in V-DMC, but is not limited thereto.

It can also be noted that in embodiments of the disclosure, the base mesh may also be referred to as a “decimated mesh”. In some embodiments, the base mesh of the current picture may be determined according to an original mesh of the current picture. Specifically, quantization or downsampling is performed on the original mesh of the current picture (i.e., a current frame) to determine the base mesh of the current picture.

Exemplarily, downsampling may be first performed on the original mesh of the current picture, to generate a base mesh with a greatly reduced number of vertices.

In embodiments of the disclosure, the base mesh includes multiple vertices. In some embodiments, the vertex in the base mesh may include each vertex in the base mesh. When the encoder uses the inter encoding mode to encode the base mesh, the encoder determines a motion vector of the vertex in the base mesh. The motion vector of the vertex is: a motion vector between a first geometric coordinate of the vertex in the base mesh corresponding to the current picture and a second geometric coordinate of a reference vertex in a reference base mesh corresponding to a reference picture of the current picture.

In embodiments of the disclosure, the motion vector of the vertex corresponds to multiple coordinate dimensions. Exemplarily, the motion vector of the vertex in a three-dimensional mesh corresponds to three coordinate dimensions of x, y, and z. When the encoder performs inter encoding on the motion vector of the vertex in the base mesh, a motion vector corresponding to each coordinate dimension for the vertex is first determined, and then an optimal encoding mode for the vertex in this coordinate dimension is determined by applying at least one encoding mode on the motion vector corresponding to each coordinate dimension. It can be noted that a first coordinate dimension, a second coordinate dimension, or a third coordinate dimension in the disclosure may be any one of x, y, and z, which is not limited in embodiments of the disclosure.

In some embodiments, the vertex in the base mesh includes each vertex in a current group in at least one group of the base mesh, or each vertex in the base mesh. Exemplarily, in a case of non-group encoding, the vertex includes each vertex in the base mesh; in a case of group-based encoding, the vertex includes each vertex in the current group in the at least one group of the base mesh. The specific implementation is based on actual circumstances and is not limited in embodiments of the disclosure, which will be described separately in subsequent embodiments.

In S1402, when inter encoding is performed on the base mesh, encoding cost estimation is performed separately for a skipping-encoding mode and for at least one prediction mode on the motion vector corresponding to each coordinate dimension for the vertex, to determine a first encoding cost corresponding to each coordinate dimension and at least one second encoding cost corresponding to each coordinate dimension.

In embodiments of the disclosure, the encoder may separately perform intra encoding and inter encoding on the base mesh, and determine a picture-level encoding mode for the base mesh of the current picture by comparing an encoding cost of intra encoding and an encoding cost of inter encoding. It can be noted that in embodiments of the disclosure, a picture level is equivalent to a frame level, and picture-level syntax information is equivalent to frame-level syntax information. When inter encoding is performed on the base mesh, the encoder performs encoding cost estimation for the at least one prediction mode on the motion vector corresponding to each coordinate dimension for the vertex, to determine an optimal encoding mode and a motion-vector encoded value for each coordinate dimension. In some embodiments, the encoded value includes encoded bits.

In some embodiments, the at least one coordinate dimension may include one or more of the x, y, and z dimensions.

In some embodiments, the encoder determines second syntax information. The second syntax information indicates intra encoding or inter encoding for the current picture. Entropy encoding is performed on the second syntax information, and obtained encoded bits are signaled into a bitstream. The second syntax information may be applied at a sequence level and/or a picture level. The specific implementation is based on actual circumstances and is not limited in embodiments of the disclosure. Exemplarily, when the second syntax information is 0, it indicates that an encoding mode of the base mesh of the current picture is an inter encoding mode; when the second syntax information is 1, it indicates that the encoding mode of the base mesh of the current picture is an intra encoding mode; when the second syntax information is 2, it indicates that the encoding mode of the base mesh of the current picture is the skipping-encoding mode; and the value 3 is reserved. The specific implementation is based on actual circumstances and is not limited in embodiments of the disclosure.

In embodiments of the disclosure, the first encoding cost corresponds to the skipping-encoding mode. The at least one second encoding cost corresponds to the at least one prediction mode. For each coordinate dimension, the encoder performs encoding cost estimation separately for the skipping-encoding mode and for the at least one prediction mode on the motion vector corresponding to the coordinate dimension for the vertex, to determine the first encoding cost corresponding to the coordinate dimension and the at least one second encoding cost corresponding to the coordinate dimension, thereby determining the first encoding cost and the at least one second encoding cost corresponding to each coordinate dimension.

In embodiments of the disclosure, the encoding cost may be evaluated and determined by a bitrate and/or a distortion cost. In some embodiments, since the motion vector of the vertex in the base mesh is usually lossless encoded, the bitrate can be used to estimate the encoding cost for each coordinate dimension. For each coordinate dimension, the encoder may perform bitrate estimation separately for the skipping-encoding mode and for the at least one prediction mode on the motion vector corresponding to the coordinate dimension for the vertex, to determine a first bitrate estimate value corresponding to the coordinate dimension and at least one second bitrate estimate value corresponding to the coordinate dimension. The first bitrate estimate value is used as the first encoding cost, and the at least one second bitrate estimate value is used as the at least one second encoding cost. In some embodiments, quality distortion can also be introduced as the encoding cost. For each coordinate dimension, the encoder may perform distortion cost estimation separately for the skipping-encoding mode and for the at least one prediction mode on the motion vector corresponding to the coordinate dimension for the vertex, to determine a first distortion cost corresponding to the coordinate dimension for the vertex and at least one second distortion cost corresponding to the coordinate dimension for the vertex. The first distortion cost is used as the first encoding cost, and the at least one second distortion cost is used as the at least one second encoding cost.

In some embodiments, in a case where the vertex in the base mesh includes each vertex in the current group in the at least one group of the base mesh: for each coordinate dimension, encoding cost estimation is performed separately for the skipping-encoding mode and for the at least one prediction mode on a motion vector corresponding to the coordinate dimension for each vertex in the current group, to determine a first encoding cost corresponding to the coordinate dimension for each vertex in the current group and at least one second encoding cost corresponding to the coordinate dimension for each vertex in the current group. A first encoding cost corresponding to the coordinate dimension for the current group and at least one second encoding cost corresponding to the coordinate dimension for the current group are determined according to the first encoding cost and the at least one second encoding cost corresponding to the coordinate dimension for each vertex in the current group. Therefore, the first encoding cost and the at least one second encoding cost corresponding to each coordinate dimension are determined.

Specifically, for each coordinate dimension, a sum or weighted average of first encoding costs corresponding to the coordinate dimension for all vertices in the current group, is calculated to determine the first encoding cost corresponding to the coordinate dimension for the current group; a sum or weighted average of second encoding costs, under the same prediction mode, corresponding to the coordinate dimension for all vertices in the current group is calculated to determine the at least one second encoding cost corresponding to the coordinate dimension for the current group. Therefore, the first encoding cost corresponding to each coordinate dimension for the current group and at least one second encoding cost corresponding to each coordinate dimension for the current group are determined.

Exemplarily, the encoding cost may be determined by a bitrate estimate value. A bitrate estimate value bitsᵢⱼ may represent a sum of bitrate estimate values for encoding, under the j-th prediction mode, a motion vector corresponding to the i-th coordinate dimension (i can be 0, 1, or 2) for each vertex in the current group. Assuming that there are 3 coordinate dimensions and 2 prediction modes, by performing encoding cost estimation separately for the skipping-encoding mode and for the 2 prediction modes, a number of 3*3=9 bitrate estimate values can be obtained.

It can be noted that for each group in the at least one group, the same processing is performed.

In some embodiments, the vertex in the base mesh includes each vertex in the base mesh. For each coordinate dimension, encoding cost estimation is performed separately for the skipping-encoding mode and for the at least one prediction mode on a motion vector corresponding to the coordinate dimension for each vertex in the base mesh, to determine a first encoding cost corresponding to the coordinate dimension for each vertex in the base mesh and at least one second encoding cost corresponding to the coordinate dimension for each vertex in the base mesh. A first encoding cost corresponding to the coordinate dimension for the base mesh and at least one second encoding cost corresponding to the coordinate dimension for the base mesh are determined according to the first encoding cost and the at least one second encoding cost corresponding to the coordinate dimension for each vertex in the base mesh. Therefore, the first encoding cost and the at least one second encoding cost corresponding to each coordinate dimension are determined.

Specifically, for each coordinate dimension, the sum or weighted average of the first encoding costs corresponding to the coordinate dimension for all vertices in the base mesh is calculated to determine the first encoding cost corresponding to the coordinate dimension for the base mesh; the sum or weighted average of the second encoding costs, under the same prediction mode, corresponding to the coordinate dimension for all vertices in the base mesh is calculated to determine the at least one second encoding cost corresponding to the coordinate dimension for the base mesh. Therefore, the first encoding cost corresponding to each coordinate dimension for the base mesh and at least one second encoding cost corresponding to each coordinate dimension for the base mesh are determined.

It can be noted that for the weighted average, a weight corresponding to each vertex may be the same or different.

In embodiments of the disclosure, each vertex corresponds to one index. Exemplarily, if the total number of vertices in the base mesh is N, indices of the vertices in the base mesh may range from 0 to N−1, where Nis an integer greater than or equal to 3. In this way, the encoder may encode the vertices in the base mesh with a preset encoding order, such as an ascending order, according to the index corresponding to each vertex. It can be noted that the preset encoding order may also be another order. The specific implementation is based on actual circumstances and is not limited in embodiments of the disclosure.

In embodiments of the disclosure, the encoder may divide the vertices in the base mesh into at least one group according to the indices of the vertices, and encode the base mesh on a group-by-group basis. For example, a group size may be 16, which indicates that the vertices in the base mesh are grouped in units of 16 vertices, with the number of vertices in the last group ranging from 1 to 16. The group size may also take other values, and the specific implementation is based on actual circumstances and is not limited in embodiments of the disclosure. For example, if the total number of vertices in the base mesh is 40 and the group size is 16, then the first group includes vertices with indices of 0 to 15, the second group includes vertices with indices of 16 to 31, and the third group includes vertices with indices of 32 to 39.

In some embodiments, the encoder may take group-based encoding as a default mode for encoding the base mesh, or may determine whether to perform group-based encoding on the base mesh according to fourth syntax information and/or fifth syntax information. The fourth syntax information indicates whether to perform group-based encoding on base meshes of all pictures in a current sequence to which the current picture belongs. The fifth syntax information indicates whether to perform group-based encoding on the base mesh of the current picture.

In some embodiments, the fourth syntax information and/or the fifth syntax information are determined. When the fourth syntax information and/or the fifth syntax information indicates to perform group-based encoding on the base mesh, grouping is performed based on an index corresponding to each vertex in the base mesh and a quantity (number) of vertices, to determine the at least one group.

Exemplarily, if the value of the fourth syntax information and/or the fifth syntax information is a first identification value, it is determined not to perform group-based encoding on the base mesh; if the value is a second identification value, it is determined to perform non-group encoding on the base mesh. In embodiments of the disclosure, the first identification value and the second identification value are different. Herein, the first identification value and the second identification value may be in a parameter form, e.g., the first identification value may be TRUE or true, and the second identification value may be FALSE or false. Alternatively, the first identification value and the second identification value may be in a numerical form, e.g., the first identification value may be 1, and the second identification value may be 0. Conversely, the first identification value may be FALSE or false, and the second identification value may be TRUE or true; or, the first identification value may be 0, and the second identification value may be 1, etc. The specific implementation is based on actual circumstances and is not limited in embodiments of the disclosure. In some embodiments, the fourth syntax information and/or the fifth syntax information each may be a parameter signaled in a profile, or may be a value of a flag, which is not specifically limited here.

In some embodiments, in the case of group-based encoding, the encoder may also determine sixth syntax information and/or seventh syntax information according to the number of vertices within a group. The sixth syntax information and/or the seventh syntax information indicates the number of vertices within a group. Exemplarily, the sixth syntax information may indicate the number of vertices for all pictures in the current sequence; the seventh syntax information may indicate the number of vertices for the current picture. That is, the sixth syntax information and/or the seventh syntax information indicates a size of the current group. The encoder performs entropy encoding on the sixth syntax information and/or the seventh syntax information, and signals obtained encoded bits into the bitstream. Exemplarily, the sixth syntax information and/or the seventh syntax information may be 16, or may be other values. The specific implementation is based on actual circumstances and is not limited in embodiments of the disclosure.

It can be noted that when the total number of vertices in the base mesh is not an integer multiple of the number of vertices within a group, the number of vertices in the last group is less than the number of vertices within a group.

In some embodiments, whether to perform group-based encoding on the base mesh may also be determined according to the sixth syntax information and/or the seventh syntax information. When the sixth syntax information and/or the seventh syntax information is a preset identification value, the encoder performs non-group encoding on the base mesh. Exemplarily, the preset identification value may be 0, or may be an identification value in a character form. The preset identification value may be preset as a reserved value. The specific implementation is based on actual circumstances and is not limited in the embodiments of the disclosure.

In some embodiments, the at least one second encoding cost corresponds to at least one of a non-prediction mode or the at least one prediction mode. The process of determining the at least one encoding cost in S1402 may be as follows, where the vertex in the following process includes each vertex in the base mesh, or each vertex in the current group in the at least one group of the base mesh.

For each coordinate dimension, a first motion-vector prediction value corresponding to the coordinate dimension for the vertex is determined under the non-prediction mode. The non-prediction mode indicates to set a motion-vector prediction value corresponding to the coordinate dimension to a preset vector prediction value. Encoding cost estimation is performed based on the first motion-vector prediction value, to determine a second encoding cost corresponding to the non-prediction mode.

Additionally or alternatively, a second motion-vector prediction value is determined according to a first weighted average of motion-vector reconstructed values corresponding to the coordinate dimension for a first number of neighbor points of the vertex. Encoding cost estimation is performed according to the second motion-vector prediction value, to determine a second encoding cost corresponding to a first prediction mode in the at least one prediction mode.

Additionally or alternatively, a first bias value is determined according to a first weighted value of the motion-vector reconstructed values corresponding to the coordinate dimension for the first number of neighbor points of the vertex. A third motion-vector prediction value is determined according to the first weighted value and the first bias value. Encoding cost estimation is performed according to the third motion-vector prediction value, to determine a second encoding cost corresponding to a second prediction mode among the at least one prediction mode.

Additionally or alternatively, a fourth motion-vector prediction value is determined according to a second weighted average of motion-vector reconstructed values corresponding to the coordinate dimension for a second number of neighbor points of the vertex. Encoding cost estimation is performed according to the fourth motion-vector prediction value, to determine a second encoding cost corresponding to a third prediction mode among the at least one prediction mode.

Additionally or alternatively, a second bias value is determined according to a second weighted value of the motion-vector reconstructed values corresponding to the coordinate dimension for the second number of neighbor points of the vertex. A fifth motion-vector prediction value is determined according to the second weighted value and the second bias value. Encoding cost estimation is performed according to the fifth motion-vector prediction value, to determine a second encoding cost corresponding to a fourth prediction mode among the at least one prediction mode.

Therefore, at least one of the second encoding cost corresponding to the non-prediction mode, the second encoding cost corresponding to the first prediction mode, the second encoding cost corresponding to the second prediction mode, the second encoding cost corresponding to the third prediction mode, and the second encoding cost corresponding to the fourth prediction mode is determined as the at least one second encoding cost.

In some embodiments, the first number of neighbor points may include all neighbor points of the vertex, and the second number of neighbor points may include some neighbor points of the vertex. The first number of neighbor points or the second number of neighbor points may include one or more of:
a vertex, in the current picture, having a connectivity with the vertex and having an encoding order prior to the vertex; and/or,
a vertex, in a reference picture corresponding to the current picture, having a same index as the vertex; and/or,
all vertices, in the reference picture, having connectivity with a co-located point of the vertex; and/or,
a vertex, in the reference picture, having a same index as a neighbor point of the vertex in the current picture.

In some embodiments, the first weighted average of the motion-vector reconstructed values corresponding to the coordinate dimension for the first number of neighbor points of the vertex may be determined by a formula of

$$\frac{{\sum }_{i = 0}^{predCount - 1} {\hat{m}}_{i}}{predCount} ,$$

where predCount is the first number, and mi is a weighted value of a motion-vector reconstructed value corresponding to the coordinate dimension for a neighbor point. Weights of different neighbor points may be the same or different.

In some embodiments, the third motion-vector prediction value may be determined by a formula of

$$\frac{( {\sum }_{i = 0}^{predCount - 1} {\hat{m}}_{i} ) + bias}{predCount} ,$$

where bias is the first bias value. When the first weighted value

$${\sum }_{i = 0}^{predCount - 1} {\hat{m}}_{i}$$

is greater than or equal to a preset threshold, the first number predCount is right shifted by a preset number of bits to determine the first bias value bias. Exemplarily, when

$${\sum }_{i = 0}^{predCount - 1} {\hat{m}}_{i} \geq 0 , bias = predCount ≫ 1.$$

In some embodiments, the second weighted average of the motion-vector reconstructed values corresponding to the coordinate dimension for the second number of neighbor points of the vertex may be determined by a formula of

$$\frac{{\sum }_{i = 0}^{{predCount}^{′} - 1} {\hat{m}}_{i}^{′}}{{predCount}^{′}} ,$$

where predCount′ is the second number, and [symbol] is a weighted value of a motion-vector reconstructed value corresponding to the coordinate dimension for the neighbor point. The weights of different neighbor points may be the same or different.

In some embodiments, the fifth motion-vector prediction value may be determined by a formula of

$$\frac{{\sum }_{i = 0}^{{predCount}^{′} - 1} {\hat{m}}_{i}^{′} + {bias}^{′}}{{predCount}^{′}} ,$$

where bias′ is the second bias value. When the second weighted value

$${\sum }_{i = 0}^{{predCount}^{′} - 1} {\hat{m}}_{i}^{′}$$

is greater than or equal to a preset threshold, the second number predCount′ is right shifted by a preset number of bits, to determine the second bias value bias′. Exemplarily, when

$${\sum }_{i = 0}^{{predCount}^{′} - 1} {\hat{m}}_{i}^{′} \geq 0 , {bias}^{′} = {predCount}^{′} ≫ 1.$$

In S1403, first syntax information is determined according to the first encoding cost and the at least one second encoding cost corresponding to each coordinate dimension.

In embodiments of the disclosure, the first syntax information indicates whether to skip encoding of the motion vector. In some embodiments, the first syntax information may apply to all dimensions of the vertex, or may apply separately to each coordinate dimension corresponding to the vertex. That is, the first syntax information may be one syntax information for all dimensions of the vertex, or may be one syntax information for each coordinate dimension of the vertex.

In embodiments of the disclosure, the first encoding cost represents an encoding performance of the skipping-encoding mode corresponding to each coordinate dimension, and the at least one second encoding cost represents an encoding performance of each prediction mode in the at least one prediction mode corresponding to each coordinate dimension. Therefore, by comparing the encoding performance of the skipping-encoding mode and the encoding performance of the at least one prediction mode corresponding to each coordinate dimension, an optimal encoding mode for the vertex can be determined, and the first syntax information is determined according to the determined optimal encoding mode.

In some embodiments, the encoder performs encoding on the first syntax information corresponding to the vertex, and signals an obtained encoded bit(s) into the bitstream.

It can be understood that at the encoding end, the base mesh of the current picture and the motion vector corresponding to each coordinate dimension for the vertex in the base mesh are determined. When inter encoding is performed on the base mesh, encoding cost estimation is performed separately for the skipping-encoding mode and for the at least one prediction mode on the motion vector corresponding to each coordinate dimension for the vertex, to determine the first encoding cost and the at least one second encoding cost corresponding to each coordinate dimension. The first encoding cost corresponds to the skipping-encoding mode. The at least one second encoding cost corresponds to the at least one prediction mode. The first syntax information is determined according to the first encoding cost and the at least one second encoding cost corresponding to each coordinate dimension. The first syntax information indicates whether to skip encoding of the motion vector. By comparing the encoding cost of the skipping-encoding mode and the encoding cost of the at least one prediction mode corresponding to each coordinate dimension for the motion vector of the vertex, an optimal processing mode (e.g., the skipping-encoding mode or an optimal prediction mode) corresponding to the coordinate dimension for the vertex can be determined, and the first syntax information indicates the optimal processing mode to the decoder, thereby improving the encoding efficiency, and further enhancing the encoding performance.

In some embodiments of the disclosure, the first syntax information applies separately to each coordinate dimension corresponding to the vertex. The above first syntax information may be determined according to the first encoding cost and the at least one second encoding cost corresponding to each coordinate dimension as follows.

For each coordinate dimension, when the first encoding cost is less than or equal to each second encoding cost of the at least one second encoding cost, the first syntax information corresponding to the coordinate dimension for the vertex is determined as a first value. The first value indicates to skip encoding of the motion vector corresponding to the coordinate dimension for the vertex.

For each coordinate dimension, when the first encoding cost is greater than or equal to any second encoding cost of the at least one second encoding cost, the first syntax information corresponding to the coordinate dimension for the vertex is determined as a second value. The second value indicates not to skip encoding of the motion vector corresponding to the coordinate dimension for the vertex.

For each coordinate dimension, when the first encoding cost is greater than or equal to any second encoding cost of the at least one second encoding cost, a target prediction mode corresponding to each coordinate dimension for the vertex is determined according to the at least one second encoding cost. Third syntax information corresponding to each coordinate dimension for the vertex is determined according to the target prediction mode corresponding to each coordinate dimension for the vertex.

In this embodiment, for each coordinate dimension, when the first encoding cost is less than or equal to each second encoding cost of the at least one second encoding cost, the motion vector corresponding to the coordinate dimension for the vertex is set to a preset value.

Herein, the first value and the second value are different. The first value may be TRUE or true, and the second value may be FALSE or false. Alternatively, the first value and the second value may be in a numerical form, e.g., the first value may be 1, and the second value may be 0. Conversely, the first value may be FALSE or false, and the second value may be TRUE or true; or, the first value may be 0, and the second value may be 1, etc. The specific implementation is based on actual circumstances and is not limited in embodiments of the disclosure.

That is, for each coordinate dimension, if the first encoding cost corresponding to the skipping-encoding mode is the minimum among the first encoding cost and the at least one second encoding cost, or is equal to a second encoding cost corresponding to each prediction mode, it is determined to skip encoding on that coordinate dimension, and the motion vector corresponding to the coordinate dimension for the vertex is set to the preset value. Exemplarily, the preset value may be 0, or may be set to another value according to actual circumstances. The specific implementation is based on actual circumstances and is not limited in embodiments of the disclosure.

For each coordinate dimension, if the first encoding cost corresponding to the skipping-encoding mode is neither the minimum among the first encoding cost and the at least one second encoding cost, nor equal to the second encoding cost corresponding to any prediction mode, it is determined not to skip encoding on that coordinate dimension, the optimal prediction mode, i.e., the target prediction mode, is determined according to the at least one second encoding cost, and the third syntax information corresponding to the coordinate dimension for the vertex is determined according to the target prediction mode.

It can be noted that in embodiments of the disclosure, third syntax information corresponding to different coordinate dimensions for the vertex may be the same or different.

In embodiments of the disclosure, at least one preset identification value corresponding to the at least one prediction mode may be pre-configured, with each preset identification value corresponding to one prediction mode in the at least one prediction mode. Therefore, the third syntax information corresponding to each coordinate dimension for the vertex may be determined according to the preset identification value corresponding to the optimal prediction mode determined for each coordinate dimension for the vertex.

In some embodiments, for each coordinate dimension, the encoder may determine the third syntax information corresponding to the coordinate dimension for the vertex according to the minimum second encoding cost in the at least one second encoding cost, thereby determining the third syntax information corresponding to each coordinate dimension for the vertex. The encoder performs the same process on each coordinate dimension, to determine the third syntax information corresponding to each coordinate dimension for the vertex.

In some embodiments, encoding is performed on the first syntax information corresponding to the vertex and the third syntax information corresponding to each coordinate dimension for the vertex, and obtained encoded bits are signaled into the bitstream.

In some embodiments, motion vector prediction is performed according to the target prediction mode corresponding to each coordinate dimension for the vertex, to determine a target motion-vector prediction value corresponding to each coordinate dimension for the vertex. A motion vector residual corresponding to each coordinate dimension for the vertex is determined according to the motion vector and the target motion-vector prediction value corresponding to each coordinate dimension for the vertex. Encoding is performed on the motion vector residual corresponding to each coordinate dimension for the vertex, to determine a motion-vector encoded value corresponding to each coordinate dimension for the vertex.

In some embodiments, the motion-vector encoded value corresponding to each coordinate dimension for the vertex is signaled into the bitstream.

In some embodiments, for each coordinate dimension, when an absolute value of a motion vector residual corresponding to the coordinate dimension for the vertex is greater than a first preset residual threshold and less than a second preset residual threshold, eighth syntax information corresponding to the coordinate dimension for the vertex is determined as a third value, and ninth syntax information corresponding to the coordinate dimension for the vertex is determined as a fourth value. The second preset residual threshold is greater than the first preset residual threshold. Encoding is performed on the motion vector residual corresponding to the coordinate dimension for the vertex, to determine the motion-vector encoded value corresponding to the coordinate dimension for the vertex, thereby determining the motion-vector encoded value corresponding to each coordinate dimension for the vertex. The motion vector residual may be positive or negative.

In some embodiments, for each coordinate dimension, when the absolute value of the motion vector residual corresponding to the coordinate dimension for the vertex is greater than or equal to the second preset residual threshold, the eighth syntax information corresponding to the coordinate dimension for the vertex is determined as the third value, and the ninth syntax information corresponding to the coordinate dimension for the vertex is determined as the third value. Encoding is performed on a remainder of the motion vector residual corresponding to the coordinate dimension for the vertex, to determine the motion-vector encoded value corresponding to the coordinate dimension for the vertex, thereby determining the motion-vector encoded value corresponding to each coordinate dimension for the vertex.

Exemplarily, the first preset residual threshold may be 0, and the second preset residual threshold may be 1. The specific implementation is based on actual circumstances and is not limited in embodiments of the disclosure.

In some embodiments, entropy encoding is performed on the eighth syntax information and the ninth syntax information corresponding to each coordinate dimension for the vertex, and obtained encoded bits, together with the motion-vector encoded value corresponding to each coordinate dimension for the vertex, are signaled into the bitstream.

In some embodiments, in the case of non-group encoding, the vertex in the above process refers to each vertex in the base mesh, the first syntax information applies to the base mesh, specifically to each coordinate dimension corresponding to the base mesh, and the first syntax information indicates whether to skip encoding on the coordinate dimension for each vertex in the base mesh. In the case of group-based encoding, the vertex in the above process refers to each vertex in the current group in the at least one group of the base mesh, the first syntax information applies to the current group, specifically to each coordinate dimension corresponding to the current group, and the first syntax information indicates whether to skip encoding on the coordinate dimension for each vertex in the current group.

In some embodiments, motion vector prediction is performed according to the target prediction mode corresponding to each coordinate dimension for the vertex, to determine the target motion-vector prediction value corresponding to each coordinate dimension for the vertex. The motion vector residual corresponding to each coordinate dimension for the vertex is determined according to the motion vector and the target motion-vector prediction value corresponding to each coordinate dimension for the vertex. Encoding is performed on the motion vector residual corresponding to each coordinate dimension for the vertex, to determine the motion-vector encoded value corresponding to each coordinate dimension for the vertex.

It can be understood that by comparing the first encoding cost and the at least one second encoding cost corresponding to each coordinate dimension for the motion vector of the vertex, the optimal encoding mode corresponding to the coordinate dimension for the vertex can be determined, and the first syntax information corresponding to each coordinate dimension is used in conjunction with the third syntax information to indicate to the decoder a decoding mode corresponding to the coordinate dimension, thereby improving the encoding efficiency, and further enhancing the encoding performance.

In some embodiments of the disclosure, the first syntax information applies to the vertex, i.e., to the three coordinate dimensions corresponding to the vertex. The above first syntax information may be determined according to the first encoding cost and the at least one second encoding cost corresponding to each coordinate dimension as follows.

When a sum of first encoding costs on the three coordinate dimensions for the vertex is less than or equal to, for each of the at least one second encoding cost, a sum of second encoding costs on the three coordinate dimensions, the first syntax information is determined as a fifth value. The fifth value indicates to skip encoding of the motion vector of the vertex.

When the sum of the first encoding costs on the three coordinate dimensions for the vertex is greater than or equal to, for each of the at least one second encoding cost, the sum of second encoding costs on the three coordinate dimensions, the first syntax information is determined as a sixth value. The sixth value indicates not to skip encoding of the motion vector of the vertex.

Herein, the fifth value and the first value may be the same or different, the sixth value and the second value may be the same or different, and the fifth value and the sixth value are different. The fifth value may be TRUE or true, and the sixth value may be FALSE or false. Alternatively, the fifth value and the sixth value may be in a numerical form, e.g., the fifth value may be 1, and the sixth value may be 0. Conversely, the fifth value may be FALSE or false, and the sixth value TRUE or true; or, the fifth value may be 0, and the sixth value may be 1, etc., which is determined according to actual circumstances and is not limited in embodiments of the disclosure.

When the sum of the first encoding costs on the three coordinate dimensions for the vertex is less than or equal to, for each of the at least one second encoding cost, the sum of second encoding costs on the three coordinate dimensions, the motion vector corresponding to the vertex is set to the preset value.

That is, for the three coordinate dimensions, a sum of first encoding costs corresponding to the skipping-encoding mode on the three coordinate dimensions is determined, and for each of the at least one second encoding cost, the sum of second encoding costs on the three coordinate dimensions is determined, so that at least one second encoding cost sum is determined. If the sum of the first encoding costs is less than or equal to each of the at least one second encoding cost sum, it is determined to skip encoding on all three coordinate dimensions for the vertex, the first syntax information is determined as the fifth value, and the motion vector corresponding to the vertex is set to the preset value. That is, motion vectors of the vertex on the three coordinate dimensions are all set to preset values.

In this embodiment, when the sum of the first encoding costs on the three coordinate dimensions for the vertex is greater than or equal to, for each of the at least one second encoding cost, the sum of second encoding costs on the three coordinate dimensions, the target prediction mode corresponding to each coordinate dimension for the vertex is determined according to the at least one second encoding cost corresponding to each coordinate dimension for the vertex. The third syntax information corresponding to each coordinate dimension for the vertex is determined according to the target prediction mode corresponding to each coordinate dimension for the vertex.

That is, for the three coordinate dimensions, if the sum of the first encoding costs is greater than or equal to each of the second encoding cost sum, it is determined not to skip encoding on all three coordinate dimensions for the vertex, the first syntax information is determined as the sixth value, and the target prediction mode is determined by comparing the at least one second encoding cost corresponding to each coordinate dimension, and then the third syntax information is determined according to the target prediction mode.

In some embodiments, encoding is performed on the first syntax information corresponding to the vertex and the third syntax information corresponding to each coordinate dimension for the vertex, and the obtained encoded bits are signaled into the bitstream.

In this embodiment, motion vector prediction is performed according to the target prediction mode corresponding to each coordinate dimension for the vertex, to determine the target motion-vector prediction value corresponding to each coordinate dimension for the vertex. The motion vector residual corresponding to each coordinate dimension for the vertex is determined according to the motion vector and the target motion-vector prediction value corresponding to each coordinate dimension for the vertex. Encoding is performed on the motion vector residual corresponding to each coordinate dimension for the vertex, to determine the motion-vector encoded value corresponding to each coordinate dimension for the vertex.

In some embodiments, the motion-vector encoded value corresponding to each coordinate dimension for the vertex is signaled into the bitstream.

In some embodiments, in the case of non-group encoding, the vertex in the above process refers to each vertex in the base mesh, the first syntax information applies to the base mesh, and the first syntax information indicates whether to skip encoding for each vertex in the base mesh, i.e., whether to skip encoding on the three coordinate dimensions for each vertex in the base mesh. In the case of group-based encoding, the vertex in the above process refers to each vertex in the current group in the at least one group of the base mesh, the first syntax information applies to the current group, and the first syntax information indicates whether to skip encoding for each vertex in the current group, i.e., whether to skip encoding on the three coordinate dimensions for each vertex in the current group.

It can be understood that by comparing the first encoding cost and the at least one second encoding cost corresponding to each coordinate dimension for the motion vector of the vertex, the optimal encoding mode for the vertex can be determined, and the first syntax information is used in conjunction with the third syntax information to indicate to the decoder the decoding mode corresponding to the coordinate dimension, thereby improving the encoding efficiency, and further enhancing the encoding performance.

In some embodiments of the disclosure, the first syntax information applies to each coordinate dimension corresponding to the vertex, and tenth syntax information applies to the vertex, i.e., to the three coordinate dimensions corresponding to the vertex. The above first syntax information may be determined according to the first encoding cost and the at least one second encoding cost corresponding to each coordinate dimension as follows.

The tenth syntax information is determined according to the first encoding cost and the at least one second encoding cost corresponding to each coordinate dimension. The tenth syntax information indicates whether to skip encoding of the motion vector of the vertex. When the tenth syntax information indicates not to skip encoding of the motion vector of the vertex, the first syntax information corresponding to each coordinate dimension for the vertex is determined according to the first encoding cost and the at least one second encoding cost corresponding to each coordinate dimension. The first syntax information indicates whether to skip encoding of the motion vector corresponding to the coordinate dimension for the vertex.

When the sum of the first encoding costs on the three coordinate dimensions for the vertex is less than or equal to, for each of the at least one second encoding cost, the sum of second encoding costs on the three coordinate dimensions, the tenth syntax information is determined as a seventh value. The seventh value indicates to skip encoding of the motion vector of the vertex.

When the sum of the first encoding costs on the three coordinate dimensions for the vertex is greater than or equal to, for each of the at least one second encoding cost, the sum of second encoding costs on the three coordinate dimensions, the tenth syntax information is determined as an eighth value. The eighth value indicates not to skip encoding of the motion vector of the vertex.

Herein, the seventh value and the first value may be the same or different, the eighth value and the second value may be the same or different, and the seventh value and the eighth value are different. The seventh value may be TRUE or true, and the eighth value may be FALSE or false; or, the seventh value and the eighth value in a numerical form, e.g., the seventh value may be 1, and the eighth value may be 0. Conversely, the seventh value may be FALSE or false, and the eighth value may be TRUE or true; or, the seventh value may be 0, and the eighth value may be 1, etc. The specific implementation is based on actual circumstances and is not limited in embodiments of the disclosure.

In this embodiment, when the sum of the first encoding costs on the three coordinate dimensions for the vertex is less than or equal to, for each of the at least one second encoding cost, the sum of second encoding costs on the three coordinate dimensions, the motion vector corresponding to the vertex is set to the preset value.

That is, for the three coordinate dimensions, the sum of the first encoding costs corresponding to the skipping-encoding mode on the three coordinate dimensions is determined, and for each of the at least one second encoding cost, the sum of second encoding costs on the three coordinate dimensions is determined, so that at least one second encoding cost sum is determined. If the sum of the first encoding costs is less than or equal to each of the at least one second encoding cost sum, it is determined to skip encoding on all three coordinate dimensions for the vertex, the tenth syntax information is determined as the seventh value, and the motion vector corresponding to the vertex is set to the preset value. That is, the motion vectors of the vertex on the three coordinate dimensions are all set to the preset values.

For each of the three coordinate dimensions, if the sum of the first encoding costs is greater than or equal to each of the at least one second encoding cost sum, it is determined not to skip encoding on all three coordinate dimensions for the vertex, and the tenth syntax information is determined as the eighth value. For each coordinate dimension, the skipping-encoding mode and the at least one prediction mode are compared in terms of encoding cost, to determine whether to skip encoding on that coordinate dimension, that is, the first syntax information corresponding to each coordinate dimension for the vertex is determined according to the first encoding cost and the at least one second encoding cost corresponding to each coordinate dimension.

Similarly, in this embodiment, the first syntax information corresponding to each coordinate dimension for the vertex may be determined according to the first encoding cost and the at least one second encoding cost corresponding to each coordinate dimension as follows.

For each coordinate dimension, when the first encoding cost is less than or equal to each second encoding cost in the at least one second encoding cost, the first syntax information corresponding to the coordinate dimension for the vertex is determined as the first value. The first value indicates to skip encoding of the motion vector corresponding to the coordinate dimension for the vertex.

For each coordinate dimension, when the first encoding cost is greater than or equal to any second encoding cost in the at least one second encoding cost, the first syntax information corresponding to the coordinate dimension for the vertex is determined as the second value. The second value indicates not to skip encoding of the motion vector corresponding to the coordinate dimension for the vertex.

When the sum of the first encoding costs on the three coordinate dimensions for the vertex is greater than or equal to, for each of the at least one second encoding cost, the sum of second encoding costs on the three coordinate dimensions, the tenth syntax information is the eighth value, which indicates not to skip encoding of the motion vector of the vertex. In this case, for each coordinate dimension, when the first encoding cost corresponding to the coordinate dimension for the vertex is less than or equal to each second encoding cost in the at least one second encoding cost corresponding to the coordinate dimension for the vertex, the motion vector corresponding to the coordinate dimension for the vertex is set to the preset value. For each coordinate dimension, when the first encoding cost corresponding to the coordinate dimension for the vertex is greater than or equal to any second encoding cost in the at least one second encoding cost corresponding to the coordinate dimension for the vertex, the target prediction mode corresponding to the coordinate dimension for the vertex is determined according to the at least one second encoding cost. The third syntax information corresponding to the coordinate dimension for the vertex is determined according to the target prediction mode corresponding to the coordinate dimension for the vertex.

In this embodiment, motion vector prediction is performed according to the target prediction mode corresponding to each coordinate dimension for the vertex, to determine the target motion-vector prediction value corresponding to each coordinate dimension for the vertex. The motion vector residual corresponding to each coordinate dimension for the vertex is determined according to the motion vector and the target motion-vector prediction value corresponding to each coordinate dimension for the vertex. Encoding is performed on the motion vector residual corresponding to each coordinate dimension for the vertex, to determine the motion-vector encoded value corresponding to each coordinate dimension for the vertex. Therefore, encoding on each coordinate dimension is achieved.

In this embodiment, in the case of non-group encoding, the vertex in the above process refers to each vertex in the base mesh. The tenth syntax information applies to the base mesh, and indicates whether to skip encoding for each vertex in the base mesh, i.e., whether to skip encoding on the three coordinate dimensions for each vertex in the base mesh. The first syntax information applies to the base mesh, specifically to each coordinate dimension corresponding to the base mesh, and first syntax information indicates whether to skip encoding on the coordinate dimension for each vertex in the base mesh.

In this embodiment, in the case of group-based encoding, the vertex in the above process refers to each vertex in the current group in the at least one group of the base mesh, and the tenth syntax information applies to the current group, and indicates whether to skip encoding for each vertex in the current group, i.e., whether to skip encoding on the three coordinate dimensions for each vertex in the current group. The tenth syntax information applies to the current group, specifically to each coordinate dimension corresponding to the current group, and the first syntax information indicates whether to skip encoding on the coordinate dimension for each vertex in the current group.

It can be understood that by comparing the first encoding cost and the at least one second encoding cost corresponding to each coordinate dimension for the motion vector of the vertex, the optimal encoding mode for the vertex can be determined, and the tenth syntax information is used in conjunction with the first syntax information or further with the third syntax information to indicate to the decoder the decoding mode corresponding to the coordinate dimension, thereby improving the encoding efficiency, and further enhancing the encoding performance.

FIG. 15 is a schematic flow chart of a decoding method according to embodiments of the disclosure. As illustrated in FIG. 15, the method includes the following.

In S1501, a bitstream is parsed to determine first syntax information corresponding to a vertex in a base mesh of a current picture. The first syntax information indicates whether to skip decoding of a motion vector. The first syntax information applies to the vertex or applies separately to at least one coordinate dimension corresponding to the vertex.

In S1502, motion-vector decoded information corresponding to the vertex is determined based on the first syntax information.

It can be noted that the decoding method of embodiments of the disclosure is applied to a decoder. The decoding method of embodiments of the disclosure may refer to an inter decoding method, and more specifically, may be an inter decoding method for a base mesh in a dynamic mesh. The decoding method can be applied to a decoder in V-DMC, but is not limited thereto.

In embodiments of the disclosure, the decoder parses the bitstream to determine the first syntax information. The first syntax information applies to the vertex. Exemplarily, the first syntax information indicates whether to skip decoding of motion vectors on three coordinate dimensions for the vertex. Alternatively, the first syntax information applies separately to each coordinate dimension in the at least one coordinate dimension corresponding to the vertex, and the first syntax information indicates separately whether to skip decoding of a motion vector corresponding to that coordinate dimension for the vertex.

In some embodiments, the decoder may directly parse out the first syntax information. Alternatively, the decoder may parse the bitstream to determine second syntax information corresponding to the base mesh. When the second syntax information indicates inter decoding, the decoder may continue to parse the bitstream to determine first syntax information corresponding to the vertex in the base mesh of the current picture. Exemplarily, when the second syntax information is 0, it indicates that a coding mode of the base mesh of the current picture is an inter coding mode; when the second syntax information is 1, it indicates that the coding mode of the base mesh of the current picture is an intra coding mode; when the second syntax information is 2, it indicates that the coding mode of the base mesh of the current picture is a skipping-coding mode; and the value 3 is reserved. The specific implementation is based on actual circumstances and is not limited in embodiments of the disclosure.

There cases are described in the following.

Case 1: In some embodiments, the decoder parses the bitstream to determine first syntax information corresponding to each coordinate dimension in at least one coordinate dimension for the vertex in the base mesh. The first syntax information indicates whether to skip decoding of the motion vector corresponding to the coordinate dimension. That is, the first syntax information applies to each coordinate dimension in the at least one coordinate dimension, and each coordinate dimension corresponds to one first syntax information. The first syntax information indicates whether to skip decoding of the motion vector corresponding to the coordinate dimension.

For each coordinate dimension in the at least one coordinate dimension, when the first syntax information corresponding to the coordinate dimension is a first value, a motion-vector decoded value corresponding to the coordinate dimension for the vertex is set to a preset value. Therefore, the motion-vector decoded value corresponding to each coordinate dimension for the vertex is determined. The motion-vector decoded information corresponding to the vertex is determined according to the motion-vector decoded value corresponding to each coordinate dimension for the vertex. The first value indicates to skip decoding of a motion vector on the coordinate dimension.

For each coordinate dimension in the at least one coordinate dimension, when the first syntax information corresponding to the coordinate dimension for the vertex is a second value, the bitstream is continued to be parsed to determine third syntax information corresponding to the coordinate dimension for the vertex. The second value indicates not to skip decoding of the motion vector on the coordinate dimension. A target prediction mode corresponding to the coordinate dimension for the vertex is determined according to the third syntax information. The bitstream is continued to be parsed to determine a motion-vector residual decoded value corresponding to the coordinate dimension for the vertex. Motion vector prediction is performed according to the target prediction mode corresponding to the coordinate dimension for the vertex, to determine a target motion-vector prediction value corresponding to the coordinate dimension for the vertex. The motion-vector decoded value corresponding to the coordinate dimension for the vertex is determined according to the target motion-vector prediction value and the motion-vector residual decoded value corresponding to the coordinate dimension for the vertex, thereby determining the motion-vector decoded value corresponding to each coordinate dimension for the vertex. The motion-vector decoded information corresponding to the vertex is determined according to the motion-vector decoded value corresponding to each coordinate dimension for the vertex.

Case 2: In some embodiments, the decoder parses the bitstream to determine the first syntax information corresponding to the vertex in the base mesh. The first syntax information indicates whether to skip decoding of a motion vector of the vertex. That is, the first syntax information applies to the three coordinate dimensions, and indicates whether to skip decoding of motion vectors on the three coordinate dimensions for the vertex.

In some embodiments, when the first syntax information is a fifth value, the motion-vector decoded information of the vertex is determined as a preset decoded value.

In some embodiments, when the first syntax information is a sixth value, for each coordinate dimension in the at least one coordinate dimension, the bitstream is continued to be parsed to determine third syntax information corresponding to the coordinate dimension for the vertex. According to the third syntax information corresponding to the coordinate dimension for the vertex, the target prediction mode corresponding to the coordinate dimension for the vertex is determined, and the bitstream is continued to be parsed to determine the motion-vector residual decoded value corresponding to the coordinate dimension for the vertex. Motion vector prediction is performed according to the target prediction mode corresponding to the coordinate dimension for the vertex, to determine a target motion-vector prediction value corresponding to the coordinate dimension for the vertex. The motion-vector decoded value corresponding to the coordinate dimension for the vertex is determined according to the target motion-vector prediction value and the motion-vector residual decoded value corresponding to the coordinate dimension for the vertex, thereby determining the motion-vector decoded value corresponding to each coordinate dimension for the vertex. The motion-vector decoded information corresponding to the vertex is determined according to the motion-vector decoded value for each coordinate dimension for the vertex.

Case 3: In some embodiments, the decoder parses the bitstream to determine tenth syntax information corresponding to the vertex in the base mesh. The tenth syntax information indicates whether to skip decoding of the motion vector of the vertex.

When the tenth syntax information indicates not to skip decoding of the motion vector of the vertex, the bitstream is continued to be parsed to determine the first syntax information corresponding to each coordinate dimension in the at least one coordinate dimension for the vertex in the base mesh. The first syntax information indicates whether to skip decoding of the motion vector corresponding to the coordinate dimension for the vertex in the base mesh.

That is, the tenth syntax information applies to the three coordinate dimensions corresponding to the vertex, and indicates whether to skip decoding of the motion vectors of the vertex on the three coordinate dimensions. The first syntax information applies separately to each coordinate dimension corresponding to the vertex, and indicates whether to skip decoding of the motion vector corresponding to the coordinate dimension.

In some embodiments, when the tenth syntax information indicates to skip decoding of the motion vector of the vertex, the motion-vector decoded value corresponding to the vertex is set to the preset value.

In some embodiments, for a third coordinate dimension in the at least one coordinate dimension, when the tenth syntax information indicates not to skip decoding of the motion vector of the vertex, and when first syntax information corresponding to a first coordinate dimension for the vertex and first syntax information corresponding to a second coordinate dimension for the vertex are both first values, first syntax information corresponding to the third coordinate dimension for the vertex is determined as the second value. Exemplarily, the three coordinate dimensions correspond to dimension indices (0,1,2), where 0 corresponds to the first coordinate dimension, 1 corresponds to the second coordinate dimension, and 2 corresponds to the third coordinate dimension. The decoder parses in an order of dimension indices.

That is, when the tenth syntax information indicates not to skip decoding of the motion vector of the vertex, and when two previously-parsed first syntax information, corresponding to coordinate dimensions with indices of 0 and 1, are both first values, first syntax information corresponding to the coordinate dimension with an index of 2 can be directly determined as the second value without further parsing.

In the above three cases, the decoder may perform motion vector prediction according to the target prediction mode corresponding to the coordinate dimension for the vertex, to determine the target motion-vector prediction value corresponding to the coordinate dimension for the vertex as follows.

When the target prediction mode corresponding to the coordinate dimension for the vertex indicates a non-prediction mode, the target motion-vector prediction value corresponding to the coordinate dimension for the vertex is set to a preset prediction value. The preset prediction value is the same as that in the encoder. Exemplarily, the preset prediction value may be 0, or may be another value. The specific implementation is based on actual circumstances and is not limited in embodiments of the disclosure.

Alternatively, when the target prediction mode corresponding to the coordinate dimension for the vertex indicates the non-prediction mode, the encoder may also directly determine the motion-vector residual decoded value corresponding to the coordinate dimension for the vertex as the motion-vector decoded value corresponding to the coordinate dimension for the vertex.

When the target prediction mode corresponding to the coordinate dimension for the vertex indicates a first prediction mode, the target motion-vector prediction value corresponding to the coordinate dimension for the vertex is determined according to a first weighted average of motion-vector reconstructed values corresponding to the coordinate dimension for a first number of neighbor points of the vertex. The process for the decoder to determine a target motion-vector prediction value corresponding to the first prediction mode is consistent with the process performed by the encoder, which will not be repeated herein.

When the target prediction mode corresponding to the coordinate dimension for the vertex indicates a second prediction mode, a first bias value is determined according to a first weighted value of motion-vector reconstructed values corresponding to the coordinate dimension for the first number of neighbor points of the vertex. The target motion-vector prediction value corresponding to the coordinate dimension for the vertex is determined according to the first weighted value and the first bias value. When the first weighted value is greater than or equal to a preset threshold, the first number is right shifted by a preset number of bits to determine the first bias value. When the first weighted value is less than the preset threshold, the first number is right shifted by the preset number of bits, and the right-shifted result is negated, to determine the first bias value. The process for the decoder to determine the target motion-vector prediction value corresponding to the second prediction mode is consistent with the process performed by the encoder, which will not be repeated herein.

When the target prediction mode corresponding to the coordinate dimension for the vertex indicates a third prediction mode, the target motion-vector prediction value corresponding to the coordinate dimension for the vertex is determined according to a second weighted average of motion-vector reconstructed values corresponding to the coordinate dimension for a second number of neighbor points of the vertex. The process for the decoder to determine the target motion-vector prediction value corresponding to the third prediction mode is consistent with the process performed by the encoder, which will not be repeated herein.

When the target prediction mode corresponding to the coordinate dimension for the vertex indicates a fourth prediction mode, a second bias value is determined according to a second weighted value of motion-vector reconstructed values corresponding to the coordinate dimension for the second number of neighbor points of the vertex. The target motion-vector prediction value corresponding to the coordinate dimension for the vertex is determined according to the second weighted value and the second bias value. When the second weighted value is greater than or equal to a preset threshold, the second number is right shifted by a preset number of bits to determine the second bias value. When the second weighted value is less than the preset threshold, the second number is right shifted by the preset number of bits, and the right-shifted result is negated, to determine the second bias value. The process for the decoder to determine the target motion-vector prediction value corresponding to the fourth prediction mode is consistent with the process performed by the encoder, which will not be repeated herein.

In the above processes, the first number of neighbor points or the second number of neighbor points includes one or more of:
a vertex, in the current picture, having a connectivity with the vertex and having an encoding order prior to the vertex; and/or,
a vertex, in a reference picture corresponding to the current picture, having the same index as the vertex; and/or,
all vertices, in the reference picture, having connectivity with a co-located point of the vertex; and/or,
a vertex, in the reference picture, having the same index as a neighbor point of the vertex in the current picture.

In the above processes, the bitstream may be continued to be parsed to determine the motion-vector residual decoded value corresponding to the coordinate dimension as follows.

The bitstream is continued to be parsed to determine eighth syntax information corresponding to the coordinate dimension and ninth syntax information corresponding to the coordinate dimension.

When the eighth syntax information is a third value and the ninth syntax information is a fourth value, the bitstream is continued to be parsed to determine the motion-vector residual decoded value corresponding to the coordinate dimension.

When the eighth syntax information is the third value and the ninth syntax information is the fourth value, the bitstream is continued to be parsed to determine a remainder of a motion vector residual corresponding to the coordinate dimension. The motion-vector residual decoded value is determined based on the remainder of the motion vector residual. The motion-vector residual decoded value may be positive or negative.

In some embodiments, the decoder may perform decoding with a group-based decoding mode or a non-group decoding mode. The decoder may use the group-based decoding mode as a default decoding mode, or may use the non-group decoding mode as the default decoding mode. The decoder may also determine whether to perform group-based decoding by parsing fourth syntax information and/or fifth syntax information.

In some embodiments, the fourth syntax information indicates whether to perform group-based decoding on the base meshes of all pictures in a sequence. The fifth syntax information indicates whether to perform group-based decoding on the base mesh of the current picture. When the fourth syntax information and/or the fifth syntax information indicates to perform group-based decoding on the base mesh, grouping is performed based on an index corresponding to each vertex in the base mesh, to determine at least one group.

In some embodiments, when the fourth syntax information and/or the fifth syntax information indicates to perform group-based decoding, the decoder may also parse the bitstream to determine sixth syntax information and/or seventh syntax information. The sixth syntax information and/or the seventh syntax information indicates the number of vertices within a group. The decoder groups the vertices in the base mesh according to the index corresponding to each vertex in the base mesh and the number of vertices in a group, to determine the at least one group.

In some embodiments, when the fourth syntax information and/or the fifth syntax information indicates not to perform group-based decoding on the base mesh, the decoder parses the bitstream to determine the first syntax information corresponding to each coordinate dimension in the at least one coordinate dimension for the base mesh.

For the group-based decoding mode, the vertex in the base mesh includes each vertex in the current group in the at least one group of the base mesh. For the non-group decoding mode, the vertex in the base mesh includes each vertex in the base mesh.

In some embodiments, for the above Case 1, for the group-based decoding mode, the bitstream may be parsed to determine the first syntax information corresponding to each coordinate dimension in the at least one coordinate dimension for the vertex in the base mesh as follows.

The bitstream is parsed to determine first syntax information corresponding to each coordinate dimension in the at least one coordinate dimension for the current group.

For each coordinate dimension, the first syntax information corresponding to the coordinate dimension for the current group is determined as first syntax information corresponding to the coordinate dimension for each vertex in the current group. In this way. the first syntax information corresponding to each coordinate dimension for each vertex in the current group is determined.

The bitstream may be continued to be parsed to determine the third syntax information corresponding to the coordinate dimension for the vertex as follows.

The bitstream is continued to be parsed to determine third syntax information corresponding to the coordinate dimension for the current group.

The third syntax information corresponding to the coordinate dimension for the current group is determined as third syntax information corresponding to the coordinate dimension for each vertex in the current group.

Exemplarily, syntax of group-based encoding for the above Case 1 may be expressed as:

```
for ( k = 0; k < 3; k++) {
  skip[k]///corresponds to first syntax information
  if (!skip[k]) {
    predMode[k]
  }
}
for ( j = 0; j < groupSize; ++) {
  for ( k = 0; k < 3; k++) {
    if (!skip[k]) {
      motion-vector residual decoded value corresponding to the k-th
coordinate dimension for the j-th vertex in the group
    }
  }
}
```

Alternatively, the syntax of group-based encoding for the above Case 1 may be expressed as:

```
for ( k = 0; k < 3; k++) {
  skip[k] ///corresponds to first syntax information
  }
for ( k = 0; k < 3; k++) {
  if (!skip[k]) {
      predMode[k]
  }
}
for ( j = 0; j < groupSize; ++) {
  for ( k = 0; k < 3; k++) {
    if (!skip[k]) {
      motion-vector residual decoded value for the k-th coordinate
dimension of the j-th vertex in the group
    }
  }
}
```

For the above Case 1, for the non-group decoding mode, the bitstream may be parsed to determine the first syntax information corresponding to each coordinate dimension for the vertex in the base mesh as follows.

The bitstream is parsed to determine the first syntax information corresponding to each coordinate dimension in the at least one coordinate dimension for the base mesh.

For each coordinate dimension, the first syntax information corresponding to the coordinate dimension for the base mesh is determined as the first syntax information corresponding to the coordinate dimension for each vertex in the base mesh. Therefore, the first syntax information corresponding to each coordinate dimension in the at least one coordinate dimension for each vertex in the base mesh is determined.

The bitstream may be continued to be parsed to determine the third syntax information corresponding to the coordinate dimension for the vertex as follows.

The bitstream is continued to be parsed to determine third syntax information corresponding to the coordinate dimension for the base mesh.

The third syntax information corresponding to the coordinate dimension for the base mesh is determined as third syntax information corresponding to the coordinate dimension for each vertex in the base mesh.

In some embodiments, for the above Case 2, for the group-based decoding mode, the bitstream may be parsed to determine the first syntax information corresponding to the vertex in the base mesh as follows.

The bitstream is parsed to determine first syntax information corresponding to the current group.

The first syntax information corresponding to the current group is determined as first syntax information corresponding to each vertex in the current group. That is, according to the first syntax information corresponding to the current group, it is determined whether to skip decoding on the three coordinate dimensions for each vertex in the current group.

The bitstream may be continued to be parsed to determine the third syntax information corresponding to the coordinate dimension for the vertex as follows.

The bitstream is continued to be parsed to determine the third syntax information corresponding to the coordinate dimension for the current group.

The third syntax information corresponding to the coordinate dimension for the current group is determined as third syntax information corresponding to the coordinate dimension for each vertex in the current group.

Exemplarily, syntax of group-based encoding for the above Case 2 may be expressed as:

```
skipOverall///corresponds to first syntax information
if (!skipOverall) {
  for ( k = 0; k < 3; k++) {
    predMode[k]
  }
  for ( j = 0; j < groupSize; ++) {
    for ( k = 0; k < 3; k++) {
      motion-vector residual decoded value for the k-th coordinate
dimension of the j-th vertex in the group
    }
  }
}
```

Alternatively, the syntax of group-based encoding for the above Case 2 may be expressed as:

```
skipOverall
if (!skipOverall) {///corresponds to first syntax information
  for ( k = 0; k < 3; k++) {
    predMode[k]
  }
}
if (!skipOverall) {
  for ( j = 0; j < groupSize; ++) {
    for ( k = 0; k < 3; k++) {
      motion-vector residual decoded value for the k-th coordinate
dimension of the j-th vertex in the group
    }
  }
}
```

For the above Case 2, for the non-group decoding mode, the bitstream may be parsed to determine the first syntax information corresponding to the vertex in the base mesh as follows.

The bitstream is parsed to determine first syntax information corresponding to the base mesh.

The first syntax information corresponding to the base mesh is determined as first syntax information corresponding to each vertex in the base mesh. That is, according to the first syntax information corresponding to the base mesh, it is determined whether to skip decoding on the three coordinate dimensions for each vertex in the base mesh.

The bitstream may be continued to be parsed to determine the third syntax information corresponding to the coordinate dimension for the vertex as follows.

The bitstream is continued to be parsed to determine the third syntax information corresponding to the coordinate dimension for the base mesh.

The third syntax information corresponding to the coordinate dimension for the base mesh is determined as the third syntax information corresponding to the coordinate dimension for each vertex in the base mesh.

In some embodiments, for the above Case 3, for the group-based decoding mode, the bitstream may be parsed to determine the tenth syntax information corresponding to the vertex in the base mesh as follows.

The bitstream is parsed to determine tenth syntax information corresponding to the current group.

The tenth syntax information corresponding to the current group is determined as tenth syntax information corresponding to each vertex in the current group.

The bitstream may be parsed to determine the first syntax information corresponding to each coordinate dimension in the at least one coordinate dimension for the vertex in the base mesh as follows.

The bitstream is parsed to determine the first syntax information corresponding to each coordinate dimension in the at least one coordinate dimension for the current group.

For each coordinate dimension, the first syntax information corresponding to the coordinate dimension for the current group is determined as the first syntax information corresponding to the coordinate dimension for each vertex in the current group. Therefore, the first syntax information corresponding to each coordinate dimension in the at least one coordinate dimension for each vertex in the current group is determined.

The bitstream may be continued to be parsed to determine the third syntax information corresponding to the coordinate dimension for the vertex as follows.

The bitstream is continued to be parsed to determine the third syntax information corresponding to the coordinate dimension for the current group.

The third syntax information corresponding to the coordinate dimension for the current group is determined as the third syntax information corresponding to the coordinate dimension for each vertex in the current group.

Exemplarily, syntax of group-based encoding for the above Case 3 may be expressed as:

```
skipOverall///corresponds to tenth syntax information
if (!skipOverall) {
  for ( k = 0; k < 3; k++) {
    skip[k]
    if (!skip[k]) {
      predMode[k]
    }
  }
}
for ( j = 0; j < groupSize; ++) {
  for ( k = 0; k < 3; k++) {
    if (!skipOverall) {
      if (!skip[k]) {///corresponds to first syntax information
        motion-vector residual decoded value for the k-th coordinate
dimension of the j-th vertex in the group
      }
    }
  }
}
```

Alternatively, the syntax of group-based encoding for the above Case 3 may be expressed as:

```
skipOverall///corresponds to tenth syntax information
if (!skipOverall) {
  for ( k = 0; k < 3; k++) {
    skip[k] ///corresponds to first syntax information
    if (!skip[k]) {
      predMode[k]
    }
  }
  for ( j = 0; j < groupSize; ++) {
    for ( k = 0; k < 3; k++) {
      if (!skip[k]) {
        motion-vector residual decoded value for the k-th coordinate
dimension of the j-th vertex in the group
      }
    }
  }
}
```

For the above Case 3, for the non-group decoding mode, the bitstream may be parsed to determine the tenth syntax information corresponding to the vertex in the base mesh as follows.

The bitstream is parsed to determine tenth syntax information corresponding to the base mesh.

The tenth syntax information corresponding to the base mesh is determined as tenth syntax information corresponding to each vertex in the base mesh.

The bitstream may be parsed to determine the first syntax information corresponding to each coordinate dimension in the at least one coordinate dimension for the vertex in the base mesh as follows.

The bitstream may be parsed to determine the first syntax information corresponding to each coordinate dimension in the at least one coordinate dimension for the base mesh.

For each coordinate dimension, the first syntax information corresponding to the coordinate dimension for the base mesh is determined as the first syntax information corresponding to the coordinate dimension for each vertex in the base mesh. Therefore, the first syntax information corresponding to each coordinate dimension in the at least one coordinate dimension for each vertex in the base mesh is determined.

The bitstream may be continued to be parsed to determine the third syntax information corresponding to the coordinate dimension for the vertex as follows.

The bitstream is continued to be parsed to determine third syntax information corresponding to the coordinate dimension for the base mesh.

The third syntax information corresponding to the coordinate dimension for the base mesh is determined as the third syntax information corresponding to the coordinate dimension for each vertex in the base mesh.

It can be understood that at the decoding end, the bitstream is parsed to determine the first syntax information corresponding to the vertex in the base mesh of the current picture. The first syntax information indicates whether to skip decoding of the motion vector. The first syntax information applies to the vertex or applies separately to each coordinate dimension corresponding to the vertex. The motion-vector decoded information corresponding to the vertex is determined based on the first syntax information. In this way, an optimal processing mode for the vertex can be determined based on the first syntax information, thereby improving a decoding efficiency, and further improving a decoding performance.

It can be noted that for the above Case 1 and Case 3, an order of content to be parsed from the bitstream shall satisfy the following conditions. Additionally, no limitation is placed on adding additional content to be parsed before, between, or after each content to be parsed.

a. A prediction mode syntax element of the first coordinate dimension shall be parsed after the first syntax information of the first coordinate dimension.

b. A prediction mode syntax element of the second coordinate dimension shall be parsed after the first syntax information of the second coordinate dimension.

c. A prediction mode syntax element of the third coordinate dimension shall be parsed after the first syntax information of the third coordinate dimension.

d. Motion-vector residual decoded values corresponding to the first coordinate dimension of all vertices within a group shall be parsed after the prediction mode syntax element of the first coordinate dimension.

e. Motion-vector residual decoded values for the second coordinate dimension of all vertices in a group shall be parsed after the prediction mode syntax element of the second coordinate dimension.

f. Motion-vector residual decoded values corresponding to the third coordinate dimension of all vertices within a group shall be parsed after the prediction mode syntax element of the third coordinate dimension.

An exemplary implementation satisfying the above conditions is as follows.

a. Parse the first syntax information of the first coordinate dimension, and proceed to step b.

b. If the first syntax information of the first coordinate dimension indicates not to skip, then first parse the prediction mode syntax element of the first coordinate dimension, then parse the first syntax information of the second coordinate dimension, and proceed to step c. If the first syntax information of the first coordinate dimension indicates to skip, then parse the first syntax information of the second coordinate dimension, and proceed to step c.

c. If the first syntax information of the second coordinate dimension indicates not to skip, then first parse the prediction mode syntax element of the second coordinate dimension, then parse the first syntax information of the third coordinate dimension, and proceed to step d. If the first syntax information of the second coordinate dimension indicates to skip, then parse the first syntax information of the third coordinate dimension, and proceed to step d.

d. If the first syntax information of the third coordinate dimension indicates not to skip, then parse the prediction mode syntax element of the third coordinate dimension, and proceed to step e. If the first syntax information of the third coordinate dimension indicates to skip, and proceed to step e.

e. If the first syntax information of the first coordinate dimension indicates not to skip, decode a motion-vector residual decoded value corresponding to the first coordinate dimension for vertex 0 within a group; if the first syntax information of the second coordinate dimension indicates not to skip, decode a motion-vector residual decoded value corresponding to the second coordinate dimension for vertex 0 within the group; if the first syntax information of the third coordinate dimension indicates not to skip, decode a motion-vector residual decoded value corresponding to the third coordinate dimension for vertex 0 within the group. If the first syntax information of the first coordinate dimension indicates not to skip, decode a motion-vector residual decoded value corresponding to the first coordinate dimension for vertex 1 within the group; if the first syntax information of the second coordinate dimension indicates not to skip, decode a motion-vector residual decoded value corresponding to the second coordinate dimension for vertex 1 within the group; if the first syntax information of the third coordinate dimension indicates not to skip, decode a motion-vector residual decoded value corresponding to the third coordinate dimension for vertex 1 within the group. If the first syntax information of the first coordinate dimension indicates not to skip, decode a motion-vector residual decoded value corresponding to the first coordinate dimension for vertex i−2 within the group; if the first syntax information of the second coordinate dimension indicates not to skip, decode a motion-vector residual decoded value corresponding to the second coordinate dimension for vertex i−2 within the group; if the first syntax information of the third coordinate dimension indicates not to skip, decode a motion-vector residual decoded value corresponding to the third coordinate dimension for vertex i−2 within the group. If the first syntax information of the first coordinate dimension indicates not to skip, decode a motion-vector residual decoded value corresponding to the first coordinate dimension for vertex i−1 within the group; if the first syntax information of the second coordinate dimension indicates not to skip, decode a motion-vector residual decoded value corresponding to the second coordinate dimension for vertex i−1 within the group; if the first syntax information of the third coordinate dimension indicates not to skip, decode a motion-vector residual decoded value corresponding to the third coordinate dimension for vertex i−1 within the group.

Another exemplary implementation is as follows:

a. Parse the first syntax information of the first coordinate dimension, the first syntax information of the second coordinate dimension, and the first syntax information of the third coordinate dimension, and proceed to step b.

b. If the first syntax information of the first coordinate dimension indicates not to skip, then parse the prediction mode syntax element of the first coordinate dimension; if the first syntax information of the second coordinate dimension indicates not to skip, then parse the prediction mode syntax element of the second coordinate dimension; if the first syntax information of the third coordinate dimension indicates not to skip, then parse the prediction mode syntax element of the third coordinate dimension, and proceed to step c.

c. If the first syntax information of the first coordinate dimension indicates not to skip, decode a motion-vector residual decoded value corresponding to the first coordinate dimension for vertex 0 within the group; if the first syntax information of the second coordinate dimension indicates not to skip, decode a motion-vector residual decoded value corresponding to the second coordinate dimension for vertex 0 within the group; if the first syntax information of the third coordinate dimension indicates not to skip, decode a motion-vector residual decoded value corresponding to the third coordinate dimension for vertex 0 within the group. If the first syntax information of the first coordinate dimension indicates not to skip, decode a motion-vector residual decoded value corresponding to the first coordinate dimension for vertex 1 within the group; if the first syntax information of the second coordinate dimension indicates not to skip, decode a motion-vector residual decoded value corresponding to the second coordinate dimension for vertex 1 within the group; if the first syntax information of the third coordinate dimension indicates not to skip, decode a motion-vector residual decoded value corresponding to the third coordinate dimension for vertex 1 within the group. If the first syntax information of the first coordinate dimension indicates not to skip, decode a motion-vector residual decoded value corresponding to the first coordinate dimension for vertex i−2 within the group; if the first syntax information of the second coordinate dimension indicates not to skip, decode a motion-vector residual decoded value corresponding to the second coordinate dimension for vertex i−2 within the group; if the first syntax information of the third coordinate dimension indicates not to skip, decode a motion-vector residual decoded value corresponding to the third coordinate dimension for vertex i−2 within the group. If the first syntax information of the first coordinate dimension indicates not to skip, decode a motion-vector residual decoded value corresponding to the first coordinate dimension for vertex i−1 within the group; if the first syntax information of the second coordinate dimension indicates not to skip, decode a motion-vector residual decoded value corresponding to the second coordinate dimension for vertex i−1 within the group; if the first syntax information of the third coordinate dimension indicates not to skip, decode a motion-vector residual decoded value corresponding to the third coordinate dimension for vertex i−1 within the group.

For the above Case 1, a bitrate saving effect for an inter base mesh can be illustrated in Table 1 as follows:

TABLE 1

| Sequence Name | Bitrate Saving (%) |
|---|---|
| soldier | −1.02 |
| levi | −2.8 |
| mitch | −2.02 |
| thomas | −9.48 |

For the above Case 2, a bitrate saving effect for the inter base mesh can be illustrated in Table 2 as follows:

TABLE 2

| Sequence Name | Bitrate Saving (%) |
|---|---|
| soldier | 0.8 |
| levi | 0.14 |
| mitch | −0.2 |
| thomas | −0.24 |

For the above Case 3, a bitrate saving effect for the inter base mesh can be illustrated in Table 3 as follows:

TABLE 3

| Sequence Name | Bitrate Saving (%) |
|---|---|
| soldier | −8.06 |
| levi | −3.02 |
| mitch | −2.98 |
| thomas | −19.54 |

It can be seen that, embodiments of the disclosure improve the coding efficiency, and further improve the coding performance.

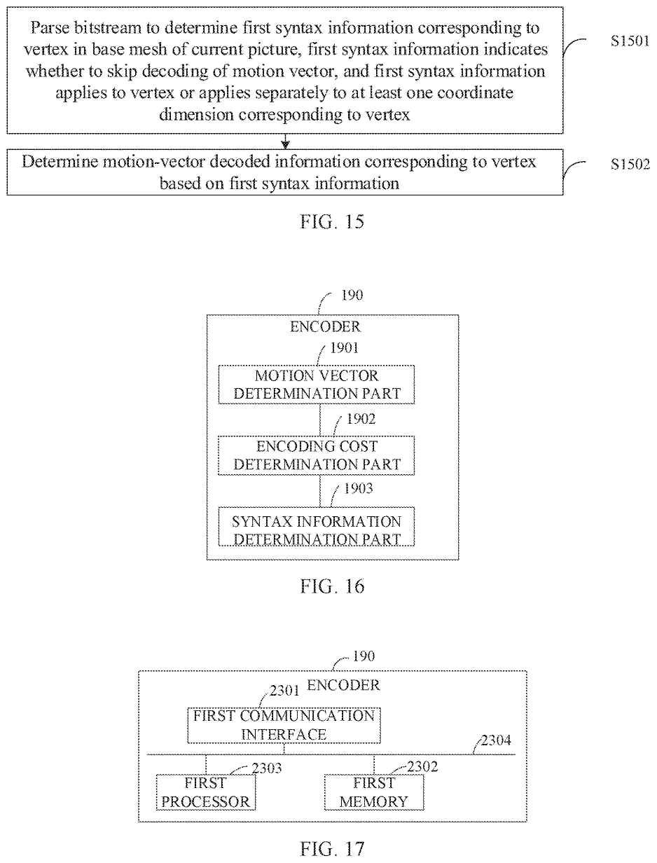

In yet another embodiment of the disclosure, based on the same inventive concept as the foregoing embodiments, reference can be made to FIG. 16, which illustrates a schematic structural diagram of an encoder provided by embodiments of the disclosure. As illustrated in FIG. 16, an encoder 190 may include a motion vector determination part 1901, an encoding cost determination part 1902, and a syntax information determination part 1903.

The motion vector determination part 1901 is configured to determine a base mesh of a current picture and a motion vector corresponding to each coordinate dimension in at least one coordinate dimension for a vertex in the base mesh.

The encoding cost determination part 1902 is configured to, when inter encoding is performed on the base mesh, perform encoding cost estimation separately for a skipping-encoding mode and for at least one prediction mode on the motion vector corresponding to each coordinate dimension for the vertex, to determine a first encoding cost corresponding to each coordinate dimension and at least one second encoding cost corresponding to each coordinate dimension. The first encoding cost corresponds to the skipping-encoding mode. The at least one second encoding cost corresponds to the at least one prediction mode.

The syntax information determination part 1903 is configured to determine first syntax information according to the first encoding cost and the at least one second encoding cost corresponding to each coordinate dimension. The first syntax information indicates whether to skip encoding of a motion vector.

In some embodiments, the encoding cost determination part 1902 is further configured to, for each coordinate dimension, when the first encoding cost is less than or equal to each second encoding cost of the at least one second encoding cost, determine the first syntax information corresponding to the coordinate dimension for the vertex as a first value. The first value indicates to skip encoding of a motion vector corresponding to the coordinate dimension for the vertex.

In some embodiments, the syntax information determination part 1903 is further configured to, for each coordinate dimension, when the first encoding cost is greater than or equal to any second encoding cost of the at least one second encoding cost, determine the first syntax information corresponding to the coordinate dimension for the vertex as a second value. The second value indicates not to skip encoding of the motion vector corresponding to the coordinate dimension for the vertex.

In some embodiments, the encoder 190 further includes an encoding part. The encoding part is configured to, for each coordinate dimension, when the first encoding cost is less than or equal to each second encoding cost of the at least one second encoding cost, set the motion vector corresponding to the coordinate dimension for the vertex to a preset value.

In some embodiments, the syntax information determination part 1903 is further configured to, for each coordinate dimension, when the first encoding cost is greater than or equal to any second encoding cost of the at least one second encoding cost, determine a target prediction mode corresponding to each coordinate dimension for the vertex according to the at least one second encoding cost, and determine third syntax information corresponding to each coordinate dimension for the vertex according to the target prediction mode corresponding to each coordinate dimension for the vertex.

In some embodiments, the encoding part is further configured to perform motion vector prediction according to the target prediction mode corresponding to each coordinate dimension for the vertex, to determine a target motion-vector prediction value corresponding to each coordinate dimension for the vertex. The encoding part is further configured to determine a motion vector residual corresponding to each coordinate dimension for the vertex according to the motion vector and the target motion-vector prediction value corresponding to each coordinate dimension for the vertex. The encoding part is further configured to perform encoding on the motion vector residual corresponding to each coordinate dimension for the vertex, to determine a motion-vector encoded value corresponding to each coordinate dimension for the vertex.

In some embodiments, the syntax information determination part 1903 is further configured to, when a sum of the first encoding costs on three coordinate dimensions for the vertex is less than or equal to, for each of the at least one second encoding cost, a sum of second encoding costs on the three coordinate dimensions, determine the first syntax information as a fifth value. The fifth value indicates to skip encoding of a motion vector of the vertex.

In some embodiments, the encoding part is further configured to, when the sum of the first encoding costs on the three coordinate dimensions for the vertex is less than or equal to, for each of the at least one second encoding cost, the sum of second encoding costs on the three coordinate dimensions, set a motion vector corresponding to the vertex to the preset value.

In some embodiments, the syntax information determination part 1903 is further configured to, when the sum of the first encoding costs on the three coordinate dimensions for the vertex is greater than or equal to, for each of the at least one second encoding cost, the sum of second encoding costs on the three coordinate dimensions, determine the first syntax information as a sixth value. The sixth value indicates not to skip encoding of the motion vector of the vertex.

In some embodiments, the syntax information determination part 1903 is further configured to, when the sum of the first encoding costs on the three coordinate dimensions for the vertex is greater than or equal to, for each of the at least one second encoding cost, the sum of second encoding costs on the three coordinate dimensions, determine the target prediction mode corresponding to each coordinate dimension for the vertex according to the at least one second encoding cost corresponding to each coordinate dimension for the vertex, and determine the third syntax information corresponding to each coordinate dimension for the vertex according to the target prediction mode corresponding to each coordinate dimension for the vertex.

In some embodiments, the syntax information determination part 1903 is further configured to determine tenth syntax information according to the first encoding cost and the at least one second encoding cost corresponding to each coordinate dimension. The tenth syntax information indicates whether to skip encoding of the motion vector of the vertex. The syntax information determination part 1903 is further configured to, when the tenth syntax information indicates not to skip encoding of the motion vector of the vertex, determine first syntax information corresponding to each coordinate dimension for the vertex according to the first encoding cost and the at least one second encoding cost corresponding to each coordinate dimension. The first syntax information indicates whether to skip encoding of the motion vector corresponding to the coordinate dimension for the vertex.

In some embodiments, the syntax information determination part 1903 is further configured to, when the sum of the first encoding costs on the three coordinate dimensions for the vertex is less than or equal to, for each of the at least one second encoding cost, the sum of second encoding costs on the three coordinate dimensions, determine the tenth syntax information as a seventh value. The seventh value indicates to skip encoding of the motion vector of the vertex.

In some embodiments, the encoding part is further configured to, when the sum of the first encoding costs on the three coordinate dimensions for the vertex is less than or equal to, for each of the at least one second encoding cost, the sum of second encoding costs on the three coordinate dimensions, set the motion vector corresponding to the vertex to the preset value.

In some embodiments, the syntax information determination part 1903 is further configured to, when the sum of the first encoding costs on the three coordinate dimensions for the vertex is greater than or equal to, for each of the at least one second encoding cost, the sum of second encoding costs on the three coordinate dimensions, determine the tenth syntax information as an eighth value. The eighth value indicates not to skip encoding of the motion vector of the vertex.

In some embodiments, the at least one second encoding cost corresponds to at least one of a non-prediction mode or the at least one prediction mode. The encoding cost determination part 1902 is further configured to, for each coordinate dimension, determine a first motion-vector prediction value corresponding to the coordinate dimension for the vertex under the non-prediction mode, where the non-prediction mode indicates to set a motion-vector prediction value corresponding to the coordinate dimension to a preset vector prediction value, and perform encoding cost estimation based on the first motion-vector prediction value to determine a second encoding cost corresponding to the non-prediction mode. Additionally or alternatively, the encoding cost determination part 1902 is further configured to determine a second motion-vector prediction value according to a first weighted average of motion-vector reconstructed values corresponding to the coordinate dimension for a first number of neighbor points of the vertex, and perform encoding cost estimation according to the second motion-vector prediction value to determine a second encoding cost corresponding to a first prediction mode in the at least one prediction mode. Additionally or alternatively, the encoding cost determination part 1902 is further configured to determine a first bias value according to a first weighted value of the motion-vector reconstructed values corresponding to the coordinate dimension for the first number of neighbor points of the vertex, determine a third motion-vector prediction value according to the first weighted value and the first bias value, and perform encoding cost estimation according to the third motion-vector prediction value to determine a second encoding cost corresponding to a second prediction mode in the at least one prediction mode. Additionally or alternatively, the encoding cost determination part 1902 is further configured to determine a fourth motion-vector prediction value according to a second weighted average of motion-vector reconstructed values corresponding to the coordinate dimension for a second number of neighbor points of the vertex, and perform encoding cost estimation according to the fourth motion-vector prediction value to determine a second encoding cost corresponding to a third prediction mode in the at least one prediction mode. Additionally or alternatively, the encoding cost determination part 1902 is further configured to determine a second bias value according to a second weighted value of the motion-vector reconstructed values corresponding to the coordinate dimension for the second number of neighbor points of the vertex, determine a fifth motion-vector prediction value according to the second weighted value and the second bias value, and perform encoding cost estimation according to the fifth motion-vector prediction value to determine a second encoding cost corresponding to a fourth prediction mode among the at least one prediction mode.

In some embodiments, the encoding cost determination part 1902 is further configured to, when the first weighted value is greater than or equal to a preset threshold, determine the first bias value by right shifting the first number by a preset number of bits.

In some embodiments, the encoding cost determination part 1902 is further configured to, when the first weighted value is less than the preset threshold, determine the first bias value by right shifting the first number by the preset number of bits and negating a right-shifted result.

In some embodiments, the encoding cost determination part 1902 is further configured to, when the second weighted value is greater than or equal to the preset threshold, determine the second bias value by right shifting the second number by the preset number of bits.

In some embodiments, the encoding cost determination part 1902 is further configured to, when the second weighted value is less than the preset threshold, determine the second bias value by right shifting the second number by the preset number of bits and negating a right-shifted result.

In some embodiments, the encoding part is further configured to perform encoding on the first syntax information corresponding to the vertex, and signal an obtained encoded bit(s) into a bitstream. Alternatively, the encoding part is further configured to perform encoding on the first syntax information corresponding to the vertex and the third syntax information corresponding to each coordinate dimension for the vertex, and signal obtained encoded bits into the bitstream.

In some embodiments, the encoding part is further configured to, for each coordinate dimension, when an absolute value of the motion vector residual corresponding to the coordinate dimension for the vertex is greater than a first preset residual threshold and less than a second preset residual threshold, determine eighth syntax information corresponding to the coordinate dimension for the vertex as a third value, and determine ninth syntax information corresponding to the coordinate dimension for the vertex as a fourth value. The second preset residual threshold is greater than the first preset residual threshold. The encoding part is further configured to perform encoding on the motion vector residual corresponding to the coordinate dimension for the vertex, to determine the motion-vector encoded value corresponding to the coordinate dimension for the vertex, thereby determining the motion-vector encoded value corresponding to each coordinate dimension for the vertex.

In some embodiments, the encoding part is further configured to, for each coordinate dimension, when the absolute value of the motion vector residual corresponding to the coordinate dimension for the vertex is greater than or equal to the second preset residual threshold, determine the eighth syntax information corresponding to the coordinate dimension for the vertex as the third value, and determine the ninth syntax information corresponding to the coordinate dimension for the vertex as the third value. The encoding part is further configured to perform encoding on a remainder of the motion vector residual corresponding to the coordinate dimension for the vertex, to determine the motion-vector encoded value corresponding to the coordinate dimension for the vertex, thereby determining the motion-vector encoded value corresponding to each coordinate dimension for the vertex.

In some embodiments, the encoding part is further configured to perform entropy encoding on the eighth syntax information and the ninth syntax information corresponding to each coordinate dimension for the vertex, and signal obtained encoded bits, together with the motion-vector encoded value corresponding to each coordinate dimension for the vertex, into the bitstream.

In some embodiments, the encoding part is further configured to determine second syntax information. The second syntax information indicates to perform intra encoding or inter encoding on the current picture. The encoding part is further configured to perform entropy encoding on the second syntax information, and signal obtained encoded bits into the bitstream.

In some embodiments, the vertex in the base mesh includes each vertex in a current group in at least one group of the base mesh. The encoding cost determination part 1902 is further configured to, for each coordinate dimension, perform encoding estimation separately for the skipping-encoding mode and for the at least one prediction mode on a motion vector corresponding to the coordinate dimension for each vertex in the current group, to determine a first encoding cost corresponding to the coordinate dimension for each vertex in the current group and at least one second encoding cost corresponding to the coordinate dimension for each vertex in the current group. The encoding cost determination part 1902 is further configured to, according to the first encoding cost and the at least one second encoding cost corresponding to the coordinate dimension for each vertex in the current group, determine a first encoding cost corresponding to the coordinate dimension for the current group and at least one second encoding cost corresponding to the coordinate dimension for the current group, thereby determining a first encoding cost corresponding to each coordinate dimension for the current group and at least one second encoding cost corresponding to each coordinate dimension for the current group.

In some embodiments, the vertex in the base mesh includes each vertex in the base mesh. The encoding cost determination part 1902 is further configured to, for each coordinate dimension, perform encoding cost estimation separately for the skipping-encoding mode and for at least one prediction mode on a motion vector corresponding to the coordinate dimension for each vertex in the base mesh, to determine a first encoding cost corresponding to the coordinate dimension for each vertex in the base mesh and at least one second encoding cost corresponding to the coordinate dimension for each vertex in the base mesh. The encoding cost determination part 1902 is further configured to, according to the first encoding cost and the at least one second encoding cost corresponding to the coordinate dimension for each vertex in the base mesh, determine a first encoding cost corresponding to the coordinate dimension for the base mesh and at least one second encoding cost corresponding to the coordinate dimension for the base mesh, thereby determining a first encoding cost corresponding to each coordinate dimension for the base mesh and the at least one second encoding cost corresponding to each coordinate dimension for the base mesh.

In some embodiments, the encoder further includes a first grouping part. The first grouping part is configured to determine fourth syntax information and/or fifth syntax information. The first grouping part is configured to, when the fourth syntax information and/or the fifth syntax information indicates to perform group-based encoding on the base mesh, perform grouping based on an index corresponding to each vertex in the base mesh and the number of vertices within a group, to determine the at least one group.

In some embodiments, the encoding part is further configured to determine sixth syntax information and/or seventh syntax information according to the number of vertices within the group. The encoding part is further configured to perform entropy encoding on the sixth syntax information and/or the seventh syntax information, and signal obtained encoded bits into the bitstream.

In some embodiments, the first number of neighbor points or the second number of neighbor points includes one or more of: a vertex, in the current picture, having a connectivity with the vertex and having an encoding order prior to the vertex; and/or, a vertex, in a reference picture corresponding to the current picture, having the same index as the vertex; and/or, all vertices, in the reference picture, having connectivity with a co-located point of the vertex; and/or, a vertex, in the reference picture, having the same index as a neighbor point of the vertex in the current picture.

It can be noted that the description of the above apparatus embodiments is similar to the description of the method embodiments, and has similar advantages as the method embodiments. For technical details not disclosed in the apparatus embodiments of the disclosure, reference can be made to the description of the method embodiments of the disclosure.

It will be appreciated that, in embodiments of the disclosure, a “part” may be a part of a circuit, a part of a processor, a part of a program or software, etc., and may of course be a module, or may be non-modular. Moreover, the components in this embodiment may be integrated into one processing unit, or each unit may exist physically separately, or two or more units may be integrated into one unit. The above integrated units may be implemented in the form of hardware or in the form of software functional modules.

If the integrated unit is implemented as a software functional module and is not sold or used as an independent product, it may be stored in a computer-readable storage medium. Based on this understanding, the technical solution of this embodiment essentially, or the part contributing to the prior art, or all or part of the technical solution, may be embodied in the form of a software product. The computer software product is stored in a storage medium and includes several instructions for causing a computer device (which may be a personal computer, a server, or a network device, etc.) or a processor to perform all or part of the steps of the method described in this embodiment. The aforementioned storage medium includes a universal serial bus (USB) flash drive, a mobile hard disk, a read only memory (ROM), a random access memory (RAM), a magnetic disk, or an optical disc, and other media that can store program codes.

Therefore, an embodiment of the disclosure provides a computer-readable storage medium applied to the encoder 190, the computer-readable storage medium storing a computer program that, when executed by a first processor, implements the method according to any of the foregoing embodiments.

Based on the composition of the encoder 190 and the computer-readable storage medium, reference can be made to FIG. 17, which illustrates a schematic diagram of a specific hardware structure of the encoder 190 provided by embodiments of the disclosure. As illustrated in FIG. 17, the encoder 190 may include a first communication interface 2301, a first memory 2302, and a first processor 2303; each component is coupled through a first bus system 2304. It can be understood that the first bus system 2304 is used to implement connection and communication between these components. In addition to a data bus, the first bus system 2304 also includes a power bus, a control bus, and a status signal bus. However, for clarity of illustration, various buses are labeled as the first bus system 2304 in FIG. 17.

The first communication interface 2301 is configured to receive and send signals during information exchange with other external network elements.

The first memory 2302 is configured to store computer programs executable on the first processor 2303.

The first processor 2303 is configured to, when executing the computer programs, perform the encoding method applied to an encoder in embodiments of the disclosure.

It can be understood that the first memory 2302 in embodiments of the disclosure may be a volatile (transitory) memory or a non-volatile (non-transitory) memory, or may include both volatile memory and non-volatile memory. The non-volatile memory may be an ROM, a programmable ROM (PROM), an erasable PROM (EPROM), an electrically EPROM (EEPROM), or a flash memory. The volatile memory may be an RAM, which acts as an external cache. By way of explanation but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DRRAM). The first memory 2302 of the systems and methods described in the disclosure is intended to include, but is not limited to, these and any other suitable types of memory.

The first processor 2303 may be an integrated circuit chip with signal processing capabilities. In implementation, the various steps of the above methods may be performed by integrated logic circuits of hardware in the first processor 2303 or by instructions in the form of software. The first processor 2303 described above may be a general-purpose processor, a digital signal processor (DSP), an application specific integrated circuit (ASIC), a field programmable gate array (FPGA) or other programmable logic devices, discrete gate or transistor logic devices, or discrete hardware components. It may implement or execute the methods, steps, and logic block diagrams disclosed in the embodiments of the disclosure. A general-purpose processor may be a microprocessor or any conventional processor. The steps of the methods disclosed in conjunction with the embodiments of the disclosure may be directly embodied as being executed by a hardware decoding processor, or by a combination of hardware and software modules in the decoding processor. The software modules may in an RAM, a flash memory, an ROM, a PROM, an electrically erasable programmable memory, a register, or other mature storage media in the art. The storage medium is located in the first memory 2302. The first processor 2303 reads information from the first memory 2302 and performs the steps of the above methods in combination with its hardware.

It will be appreciated that the embodiments described in the disclosure may be implemented in hardware, software, firmware, middleware, microcode, or a combination thereof. For hardware implementation, a processing unit may be implemented in one or more ASICs, DSPs, digital signal processing devices (DSPDs), programmable logic devices (PLDs), FPGAs, general-purpose processors, controllers, microcontrollers, microprocessors, other electronic units for performing the functions described in the disclosure, or a combination thereof. For software implementation, the techniques described in the disclosure may be implemented by modules (e.g., procedures, functions, etc.) that perform the functions described in the disclosure. Software codes may be stored in a memory and executed by a processor. The memory may be implemented within the processor or external to the processor.

Optionally, as another embodiment, the first processor 2303 is further configured to, when executing the computer program, perform the encoding method applied to an encoder according to any of the foregoing embodiments.

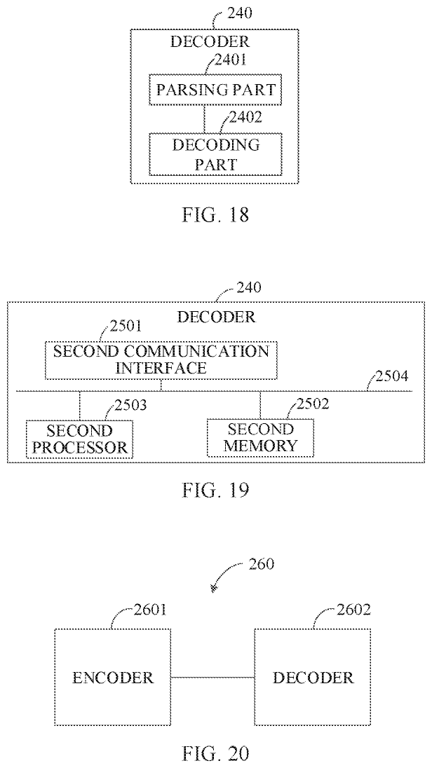

Based on the same inventive concept as the foregoing embodiments, reference can be made to FIG. 18, which illustrates a schematic structural diagram of a decoder provided by embodiments of the disclosure. As illustrated in FIG. 18, the decoder 240 may include a parsing part 2401 and a decoding part 2402.

The parsing part 2401 is configured to parse a bitstream to determine first syntax information corresponding to a vertex in a base mesh of a current picture. The first syntax information indicates whether to skip decoding of a motion vector. The first syntax information applies to the vertex or applies separately to at least one coordinate dimension corresponding to the vertex.

The decoding part 2402 is configured to determine motion-vector decoded information corresponding to the vertex based on the first syntax information.

In some embodiments, the bitstream may be parsed to determine the first syntax information corresponding to the vertex in the base mesh of the current picture as follows.

The bitstream is parsed to determine second syntax information corresponding to the base mesh.

In some embodiments, the parsing part 2401 is further configured to, when the second syntax information indicates inter decoding, continue to parse the bitstream to determine the first syntax information corresponding to the vertex in the base mesh of the current picture.

In some embodiments, the parsing part 2401 is further configured to parse the bitstream to determine first syntax information corresponding to each coordinate dimension in at least one coordinate dimension for the vertex in the base mesh. The first syntax information indicates whether to skip decoding of a motion vector corresponding to the coordinate dimension.

In some embodiments, the parsing part 2401 is further configured to parse the bitstream to determine the first syntax information corresponding to the vertex in the base mesh. The first syntax information indicates whether to skip decoding of a motion vector of the vertex.

In some embodiments, the parsing part 2401 is further configured to parse the bitstream to determine tenth syntax information corresponding to the vertex in the base mesh. The tenth syntax information indicates whether to skip decoding of the motion vector of the vertex. The parsing part 2401 is further configured to, when the tenth syntax information indicates not to skip decoding of the motion vector of the vertex, continue to parse the bitstream to determine the first syntax information corresponding to each coordinate dimension in the at least one coordinate dimension for the vertex in the base mesh. The first syntax information indicates whether to skip decoding of a motion vector corresponding to the coordinate dimension for the vertex in the base mesh.

In some embodiments, the decoding part 2402 is further configured to, when the tenth syntax information indicates to skip decoding of the motion vector of the vertex, set a motion-vector decoded value corresponding to the vertex to a preset value.

In some embodiments, the decoding part 2402 is further configured to, for each coordinate dimension, when the first syntax information corresponding to the coordinate dimension is a first value, set a motion-vector decoded value corresponding to the coordinate dimension for the vertex to a preset value, thereby determining the motion-vector decoded value corresponding to each coordinate dimension for the vertex. The decoding part 2402 is further configured to determine the motion-vector decoded information corresponding to the vertex according to the motion-vector decoded value corresponding to each coordinate dimension the vertex.

In some embodiments, the decoding part 2402 is further configured to, for each coordinate dimension, when the first syntax information corresponding to the coordinate dimension for the vertex is a second value, continue to parse the bitstream to determine third syntax information corresponding to the coordinate dimension for the vertex. The decoding part 2402 is further configured to determine a target prediction mode corresponding to the coordinate dimension for the vertex according to the third syntax information, and continue to parse the bitstream to determine the motion-vector residual decoded value corresponding to the coordinate dimension for the vertex. The decoding part 2402 is further configured to perform motion vector prediction according to the target prediction mode corresponding to the coordinate dimension for the vertex, to determine a target motion-vector prediction value corresponding to the coordinate dimension for the vertex. The decoding part 2402 is further configured to determine the motion-vector decoded value corresponding to the coordinate dimension for the vertex according to the target motion-vector prediction value and the motion-vector residual decoded value corresponding to the coordinate dimension for the vertex, thereby determining the motion-vector decoded value corresponding to each coordinate dimension for the vertex. The decoding part 2402 is further configured to determine the motion-vector decoded information corresponding to the vertex according to the motion-vector decoded value corresponding to each coordinate dimension for the vertex.

In some embodiments, the parsing part 2402 is further configured to, for a third coordinate dimension in the at least one coordinate dimension, when the tenth syntax information indicates not to skip decoding of the motion vector of the vertex, and when first syntax information corresponding to a first coordinate dimension for the vertex and first syntax information corresponding to a second coordinate dimension for the vertex are both first values, determine first syntax information corresponding to the third coordinate dimension for the vertex as the second value.

In some embodiments, the decoding part 2402 is further configured to, when the first syntax information is a fifth value, determine the motion-vector decoded information of the vertex as a preset decoded value.

In some embodiments, the decoding part 2402 is further configured to, when the first syntax information is a sixth value, for each coordinate dimension, continue to parse the bitstream to determine the third syntax information corresponding to the coordinate dimension for the vertex. The decoding part 2402 is further configured to, according to the third syntax information corresponding to the coordinate dimension for the vertex, determine the target prediction mode corresponding to the coordinate dimension for the vertex, and continue to parse the bitstream to determine the motion-vector residual decoded value corresponding to the coordinate dimension for the vertex. The decoding part 2402 is further configured to perform motion vector prediction according to the target prediction mode corresponding to the coordinate dimension for the vertex, to determine the target motion-vector prediction value corresponding to the coordinate dimension for the vertex. The decoding part 2402 is further configured to determine the motion-vector decoded value corresponding to the coordinate dimension for the vertex according to the target motion-vector prediction value and the motion-vector residual decoded value corresponding to the coordinate dimension for the vertex, thereby determining the motion-vector decoded value corresponding to each coordinate dimension for the vertex. The decoding part 2402 is further configured to determine the motion-vector decoded information corresponding to the vertex according to the motion-vector decoded value corresponding to each coordinate dimension for the vertex.

In some embodiments, the decoding part 2402 is further configured to, when the target prediction mode corresponding to the coordinate dimension for the vertex indicates a non-prediction mode, set the target motion-vector prediction value corresponding to the coordinate dimension for the vertex to a preset prediction value.

In some embodiments, the decoding part 2402 is further configured to, when the target prediction mode corresponding to the coordinate dimension for the vertex indicates the non-prediction mode, determine the motion-vector residual decoded value corresponding to the coordinate dimension for the vertex as the motion-vector decoded value corresponding to the coordinate dimension for the vertex.

In some embodiments, the decoding part 2402 is further configured to, when the target prediction mode corresponding to the coordinate dimension for the vertex indicates a first prediction mode, determine the target motion-vector prediction value corresponding to the coordinate dimension for the vertex according to a first weighted average of motion-vector reconstructed values corresponding to the coordinate dimension for a first number of neighbor points of the vertex.

In some embodiments, the decoding part 2402 is further configured to, when the target prediction mode corresponding to the coordinate dimension for the vertex indicates a second prediction mode, determine a first bias value according to a first weighted value of the motion-vector reconstructed values corresponding to the coordinate dimension for the first number of neighbor points of the vertex; and determine the target motion-vector prediction value corresponding to the coordinate dimension for the vertex according to the first weighted value and the first bias value.

In some embodiments, the decoding part 2402 is further configured to, when the target prediction mode corresponding to the coordinate dimension for the vertex indicates a third prediction mode, determine the target motion-vector prediction value corresponding to the coordinate dimension for the vertex according to a second weighted average of motion-vector reconstructed values corresponding to the coordinate dimension for a second number of neighbor points of the vertex.

In some embodiments, the decoding part 2402 is further configured to, when the target prediction mode corresponding to the coordinate dimension for the vertex indicates a fourth prediction mode, determine a second bias value according to a second weighted value of the motion-vector reconstructed values corresponding to the coordinate dimension for the second number of neighbor points of the vertex; and determine the motion-vector prediction value corresponding to the coordinate dimension for the vertex according to the second weighted value and the second bias value.

In some embodiments, the decoding part 2402 is further configured to, when the first weighted value is greater than or equal to a preset threshold, determine the first bias value by right shifting the first number by a preset number of bits.

In some embodiments, the decoding part 2402 is further configured to, when the first weighted value is less than the preset threshold, determine the first bias value by right shifting the first number by the preset number of bits and negating a right-shifted result.

In some embodiments, the decoding part 2402 is further configured to, when the second weighted value is greater than or equal to the preset threshold, determine the second bias value by right shifting the second number by the preset number of bits.

In some embodiments, the decoding part 2402 is further configured to, when the second weighted value is less than the preset threshold, determine the second bias value by right shifting the second number by the preset number of bits and negating the right-shifted result.

In some embodiments, the first number of neighbor points or the second number of neighbor points includes one or more of: a vertex, in the current picture, having a connectivity with the vertex and having an encoding order prior to the vertex; and/or, a vertex, in a reference picture corresponding to the current picture, having a same index as the vertex; and/or, all vertices, in the reference picture, having connectivity with a co-located point of the vertex; and/or, a vertex, in the reference picture, having a same index as a neighbor point of the vertex in the current picture.

In some embodiments, the vertex in the base mesh includes each vertex in a current group in at least one group of the base mesh. The parsing part 2401 is further configured to parse the bitstream to determine first syntax information corresponding to each coordinate dimension in the at least one coordinate dimension for the current group. The parsing part 2401 is further configured to, for each coordinate dimension, determine the first syntax information corresponding to the coordinate dimension for the current group as first syntax information corresponding to the coordinate dimension for each vertex in the current group, thereby determining first syntax information corresponding to each coordinate dimension for each vertex in the current group.

In some embodiments, the vertex in the base mesh includes each vertex in the base mesh. The parsing part 2401 is further configured to parse the bitstream to determine first syntax information corresponding to each coordinate dimension in the at least one coordinate dimension the base mesh. The parsing part 2401 is further configured to, for each coordinate dimension, determine the first syntax information corresponding to the coordinate dimension for the base mesh as first syntax information corresponding to the coordinate dimension for each vertex in the base mesh, thereby determining the first syntax information corresponding to each coordinate dimension for each vertex in the base mesh.

In some embodiments, the vertex in the base mesh includes each vertex in the current group in the at least one group of the base mesh. The parsing part 2401 is further configured to parse the bitstream to determine first syntax information corresponding to the current group; and determine the first syntax information corresponding to the current group as first syntax information corresponding to each vertex in the current group.

In some embodiments, the vertex in the base mesh includes each vertex in the base mesh. The parsing part 2401 is further configured to parse the bitstream to determine first syntax information corresponding to the base mesh; and determine the first syntax information corresponding to the base mesh as first syntax information corresponding to each vertex in the base mesh.

In some embodiments, the vertex in the base mesh includes each vertex in the current group in the at least one group of the base mesh. The parsing part 2401 is further configured to parse the bitstream to determine tenth syntax information corresponding to the current group;

and determine the tenth syntax information corresponding to the current group as tenth syntax information corresponding to each vertex in the current group.

In some embodiments, the vertex in the base mesh includes each vertex in the base mesh. The parsing part 2401 is further configured to parse the bitstream to determine tenth syntax information corresponding to the base mesh; and determine the tenth syntax information corresponding to the base mesh as tenth syntax information corresponding to each vertex in the base mesh.

In some embodiments, the vertex in the base mesh includes each vertex in the current group in the at least one group of the base mesh. The parsing part 2401 is further configured to continue to parse the bitstream to determine third syntax information corresponding to the coordinate dimension for the current group; and determine the third syntax information corresponding to the coordinate dimension for the current group as third syntax information corresponding to the coordinate dimension for each vertex in the current group.

In some embodiments, the vertex in the base mesh includes each vertex in the base mesh. The parsing part 2401 is further configured to continue to parse the bitstream to determine third syntax information corresponding to the coordinate dimension for the base mesh; and determine the third syntax information corresponding to the coordinate dimension for the base mesh as third syntax information corresponding to the coordinate dimension for each vertex in the base mesh.

In some embodiments, the parsing part 2401 is further configured to parse the bitstream to determine fourth syntax information and/or fifth syntax information.

The decoder 240 further includes a second grouping part. The second grouping part is configured to, when the fourth syntax information and/or the fifth syntax information indicates to perform group-based decoding on the base mesh, perform grouping based on an index corresponding to each vertex in the base mesh, to determine the at least one group.

In some embodiments, the parsing part 2401 is further configured to, when the fourth syntax information and/or the fifth syntax information indicates not to perform group-based decoding on the base mesh, parse the bitstream to determine the first syntax information corresponding to each coordinate dimension for the base mesh.

In some embodiments, the second grouping part is further configured to parse the bitstream to determine sixth syntax information and/or seventh syntax information, where the sixth syntax information and/or the seventh syntax information indicates the number of vertices within a group; and perform grouping on the vertices in the base mesh according to the index corresponding to each vertex in the base mesh and the number of vertices within the group, to determine the at least one group.

In some embodiments, the parsing part 2401 is further configured to continue to parse the bitstream to determine eighth syntax information and ninth syntax information corresponding to the coordinate dimension. The parsing part 2401 is further configured to, when the eighth syntax information is a third value and the ninth syntax information is a fourth value, continue to parse the bitstream to determine the motion-vector residual decoded value corresponding to the coordinate dimension.

In some embodiments, the decoding part 2402 is further configured to, when the eighth syntax information is the third value and the ninth syntax information is the fourth value, continue to parse the bitstream to determine a remainder of a motion vector residual corresponding to the coordinate dimension; and determine the motion-vector residual decoded value according to the remainder of the motion vector residual.

It can be understood that, in this embodiment, a “part” may be a part of a circuit, a part of a processor, a part of a program or software, etc., and may of course be a module, or may be non-modular. Moreover, the components in this embodiment may be integrated into one processing unit, or each unit may exist physically separately, or two or more units may be integrated into one unit. The above integrated units may be implemented in the form of hardware or in the form of software functional modules.

If the integrated unit is implemented as a software functional module and is not sold or used as an independent product, it may be stored in a computer-readable storage medium. Based on this understanding, this embodiment provides a computer-readable storage medium applied to the decoder 240, the computer-readable storage medium storing a computer program that, when executed by a second processor, implements the method according to any of the foregoing embodiments.

It can be noted that the description of the above apparatus embodiments is similar to the description of the method embodiments, and has similar advantages as the method embodiments. For technical details not disclosed in the apparatus embodiments of the disclosure, reference can be made to the description of the method embodiments of the disclosure.

Based on the composition of the decoder 240 and the computer-readable storage medium, reference can be made to FIG. 19, which illustrates a schematic diagram of a specific hardware structure of the decoder 240 provided by embodiments of the disclosure. As illustrated in FIG. 19, the decoder 240 may include a second communication interface 2501, a second memory 2502, and a second processor 2503; each component is coupled through a second bus system 2504. It can be understood that the second bus system 2504 is configured to implement connection and communication between these components. In addition to a data bus, the second bus system 2504 also includes a power bus, a control bus, and a status signal bus. However, for clarity of illustration, various buses are labeled as the second bus system 2504 in FIG. 19.

The second communication interface 2501 is configured to receive and send signals during information exchange with other external network elements.

The second memory 2502 is configured to store computer programs executable on the second processor 2503.

The second processor 2503 is configured to, when executing the computer programs, perform the decoding method applied to a decoder provided by the embodiments of the disclosure.

Optionally, as another embodiment, the second processor 2503 is further configured to, when executing the computer programs, perform the method according to any of the foregoing embodiments.

It can be understood that the second memory 2502 has similar hardware functions to the first memory 2302, and the second processor 2503 has similar hardware functions to the first processor 2303, which will not be repeated herein.

In yet another embodiment of the disclosure, reference can be made to FIG. 20, which illustrates a schematic structural diagram of an encoding and decoding system provided by embodiments of the disclosure. As illustrated in FIG. 20, the encoding and decoding system 260 may include an encoder 2601 and a decoder 2602.

In embodiments of the disclosure, the encoder 2601 may be the encoder according to any of the foregoing embodiments, and the decoder 2602 may be the decoder according to any of the foregoing embodiments.

It can be noted that in the disclosure, the terms “include”, “comprise”, or any other variation thereof are intended to cover non-exclusive inclusion, such that a process, method, object, or apparatus that includes a list of elements includes not only those elements but also other elements not expressly listed, or elements inherent to such process, method, object, or apparatus. Without further limitation, an element defined by the phrase “include a . . . ” does not preclude the presence of additional identical elements in the process, method, object, or apparatus that includes the element.

The sequence numbers of the above embodiments of the disclosure are merely for illustration and rather than representation of the superiority or inferiority of the embodiments.

The methods disclosed in the several method embodiments provided in the disclosure may be combined arbitrarily without conflict to obtain new method embodiments.

The features disclosed in the several product embodiments provided in the disclosure may be combined arbitrarily without conflict to obtain new product embodiments.

The features disclosed in the several method or apparatus embodiments provided in the disclosure may be combined arbitrarily without conflict to obtain new method embodiments or new apparatus embodiments.

The above description is merely specific implementations of the disclosure, but the scope of protection of the disclosure is not limited thereto. Any variations or substitutions readily conceivable by a person skilled in the art within the technical scope disclosed in the disclosure shall be covered by the scope of protection of the disclosure. Therefore, the scope of protection of the disclosure shall be subject to the scope of protection of the claims.

### INDUSTRIAL APPLICABILITY

In embodiments of the disclosure, at an encoding end, a base mesh of a current picture and a motion vector corresponding to each coordinate dimension for a vertex in the base mesh are determined. When inter encoding is performed on the base mesh, encoding cost estimation is performed separately for a skipping-encoding mode and for at least one prediction mode on the motion vector corresponding to each coordinate dimension for the vertex, to determine a first encoding cost corresponding to each coordinate dimension and at least one second encoding cost corresponding to each coordinate dimension. The first encoding cost corresponds to the skipping-encoding mode, and the at least one second encoding cost corresponds to the at least one prediction mode. First syntax information is determined according to the first encoding cost and the at least one second encoding cost corresponding to each coordinate dimension. The first syntax information indicates whether to skip encoding of a motion vector. At a decoding side, a bitstream is parsed to determine first syntax information corresponding to the vertex in the base mesh of the current picture. The first syntax information indicates whether to skip decoding of the motion vector. The first syntax information applies to the vertex or applies separately to each coordinate dimension corresponding to the vertex. Motion-vector decoded information corresponding to the vertex is determined based on the first syntax information. In this way, by comparing the encoding cost of the skipping-encoding mode and the encoding cost of the at least one prediction mode corresponding to each coordinate dimension for the motion vector of the vertex in the base mesh, an optimal processing mode corresponding to the coordinate dimension for the vertex, such as the skipping-encoding mode or an optimal prediction mode, can be determined, and the first syntax information indicates the optimal processing mode to the decoder, thereby improving a coding efficiency, and further improving a coding performance.

What is claimed is:

1. A decoding method, applied to a decoder, the method comprising:
parsing a bitstream to determine first syntax information corresponding to a vertex in a current group, wherein the first syntax information indicates whether a motion vector corresponding to at least one coordinate dimension for the vertex in the current group is inferred to be a preset value; and
determining motion-vector decoded information corresponding to the vertex in the current group based on the first syntax information.

2. The method of claim 1, wherein parsing the bitstream to determine the first syntax information corresponding to the vertex in the current group comprises:
parsing the bitstream to determine second syntax information; and
in response to that the second syntax information indicates inter decoding, continuing to parse the bitstream to determine the first syntax information corresponding to the vertex in the current group.

3. The method of claim 1, wherein parsing the bitstream to determine the first syntax information corresponding to the vertex in the current group comprises:
parsing the bitstream to determine first syntax information corresponding to each coordinate dimension in at least one coordinate dimension for the vertex in the current group, wherein the first syntax information corresponding to each coordinate dimension indicates whether a motion vector corresponding to the coordinate dimension for the vertex in the current group is inferred to be the preset value.

4. The method of claim 1, wherein parsing the bitstream to determine the first syntax information corresponding to the vertex in the current group comprises:
parsing the bitstream to determine tenth syntax information corresponding to the vertex in the current group, wherein the tenth syntax information indicates whether a motion vector for the vertex in the current group is inferred to be the preset value; and
in response to that the tenth syntax information has a second value, continuing to parse the bitstream to determine first syntax information corresponding to each coordinate dimension in at least one coordinate dimension for the vertex in the current group.

5. The method of claim 4, further comprising:
in response to that the tenth syntax information has a first value, inferring a motion-vector decoded value corresponding to the vertex in the current group to be the preset value.

6. The method of claim 3, wherein determining the motion-vector decoded information corresponding to the vertex in the current group based on the first syntax information comprises:
for each coordinate dimension in the at least one coordinate dimension, in response to that the first syntax information corresponding to the coordinate dimension has a first value, inferring a motion-vector decoded value corresponding to the coordinate dimension for the vertex in the current group to be the preset value.

7. The method of claim 3, wherein determining the motion-vector decoded information corresponding to the vertex in the current group based on the first syntax information comprises:
for each coordinate dimension in the at least one coordinate dimension, in response to that the first syntax information corresponding to the coordinate dimension has a second value, continuing to parse the bitstream to determine third syntax information corresponding to the coordinate dimension for the vertex in the current group;
determining a target prediction mode corresponding to the coordinate dimension for the vertex in the current group according to the third syntax information, and continuing to parse the bitstream to determine a motion-vector residual decoded value corresponding to the coordinate dimension for the vertex in the current group;
performing motion vector prediction according to the target prediction mode corresponding to the coordinate dimension for the vertex in the current group, to determine a target motion-vector prediction value corresponding to the coordinate dimension for the vertex in the current group; and
determining a motion-vector decoded value corresponding to the coordinate dimension for the vertex in the current group according to the target motion-vector prediction value and the motion-vector residual decoded value corresponding to the coordinate dimension for the vertex in the current group.

8. The method of claim 4, further comprising:
for a third coordinate dimension in the at least one coordinate dimension, in response to that the tenth syntax information has the second value, and that each of first syntax information corresponding to a first coordinate dimension for the vertex in the current group and first syntax information corresponding to a second coordinate dimension for the vertex in the current group has a first value, determining that first syntax information corresponding to the third coordinate dimension for the vertex in the current group has the second value.

9. The method of claim 7, wherein performing motion vector prediction according to the target prediction mode corresponding to the coordinate dimension for the vertex in the current group, to determine the target motion-vector prediction value corresponding to the coordinate dimension for the vertex in the current group, comprises:
in response to that the target prediction mode corresponding to the coordinate dimension for the vertex in the current group indicates a non-prediction mode, inferring the target motion-vector prediction value corresponding to the coordinate dimension for the vertex in the current group to be a preset prediction value.

10. The method of claim 7, further comprising:
in response to that the target prediction mode corresponding to the coordinate dimension for the vertex in the current group indicates a non-prediction mode, determining the motion-vector residual decoded value corresponding to the coordinate dimension for the vertex in the current group as the motion-vector decoded value corresponding to the coordinate dimension for the vertex in the current group.

11. The method of claim 7, wherein performing motion vector prediction according to the target prediction mode corresponding to the coordinate dimension for the vertex in the current group, to determine the target motion-vector prediction value corresponding to the coordinate dimension for the vertex in the current group, comprises:
in response to that the target prediction mode corresponding to the coordinate dimension for the vertex in the current group indicates a first prediction mode, determining the target motion-vector prediction value corresponding to the coordinate dimension for the vertex according to a first weighted average of motion-vector reconstructed values corresponding to the coordinate dimension for a first quantity of neighbor points of the vertex.

12. The method of claim 7, wherein performing motion vector prediction according to the target prediction mode corresponding to the coordinate dimension for the vertex in the current group, to determine the target motion-vector prediction value corresponding to the coordinate dimension for the vertex in the current group, comprises:
determining a first bias value according to a first weighted value of motion-vector reconstructed values corresponding to the coordinate dimension for a first quantity of neighbor points of the vertex in the current group; and
determining the target motion-vector prediction value corresponding to the coordinate dimension for the vertex in the current group according to the first weighted value and the first bias value.

13. The method of claim 12, wherein determining the first bias value according to the first weighted value of the motion-vector reconstructed value corresponding to the coordinate dimension for the first quantity of neighbor points of the vertex comprises:
in response to that the first weighted value is greater than or equal to a preset threshold, determining the first bias value by right shifting the first quantity by a preset number of bits.

14. The method of claim 12, wherein determining the first bias value according to the first weighted value of the motion-vector reconstructed value corresponding to the coordinate dimension for the first quantity of neighbor points of the vertex in the current group comprises:
in response to that the first weighted value is less than a preset threshold, determining the first bias value by negating a result of right shifting the first quantity by a preset number of bits.

15. The method of claim 11, wherein the first quantity of neighbor points comprises one or more of:
a first vertex, in a current picture, having connectivity with the vertex in the current group and having an encoding order prior to the vertex in the current group;
a second vertex, in a reference picture corresponding to the current picture, having a same index as the vertex in the current group;
a third vertex, in the reference picture, having connectivity with a co-located point of the vertex in the current group; or
a fourth vertex, in the reference picture, having a same index as a neighbor point of the vertex in the current group in the current picture.

16. The method of claim 1, further comprising:
parsing the bitstream to determine fourth syntax information and/or fifth syntax information; and
in response to that the fourth syntax information and/or the fifth syntax information indicates to perform group-based decoding on a base mesh of a current picture, performing grouping based on an index corresponding to each vertex in the base mesh, to determine at least one group comprising the current group.

17. The method of claim 7, wherein continuing to parse the bitstream to determine the motion-vector residual decoded value corresponding to the coordinate dimension comprises:
continuing to parse the bitstream to determine eighth syntax information corresponding to the coordinate dimension and ninth syntax information corresponding to the coordinate dimension; and
in response to that the eighth syntax information has a third value and the ninth syntax information has a fourth value, continuing to parse the bitstream to determine the motion-vector residual decoded value corresponding to the coordinate dimension.

18. The method of claim 17, wherein continuing to parse the bitstream to determine the motion-vector residual decoded value corresponding to the coordinate dimension comprises:
in response to that the eighth syntax information has the third value and the ninth syntax information has the third value, continuing to parse the bitstream to determine a remainder of a motion vector residual corresponding to the coordinate dimension; and
determining the motion-vector residual decoded value according to the remainder of the motion vector residual.

19. An encoding method, applied to an encoder, the method comprising:
determining a motion vector corresponding to each coordinate dimension in at least one coordinate dimension for a vertex in a current group;
when performing inter encoding on the current group, performing encoding cost estimation separately for a skipping-encoding mode and for at least one prediction mode on the motion vector corresponding to each coordinate dimension for the vertex in the current group, to determine a first encoding cost corresponding to each coordinate dimension and at least one second encoding cost corresponding to each coordinate dimension, wherein the first encoding cost corresponds to the skipping-encoding mode, and the at least one second encoding cost corresponds to the at least one prediction mode; and
determining first syntax information according to the first encoding cost and the at least one second encoding cost corresponding to each coordinate dimension, wherein the first syntax information indicates whether the motion vector corresponding to the at least one coordinate dimension for the vertex in the current group is inferred to be a preset value.

20. A decoder, comprising a memory and a processor, wherein the memory is configured to store computer programs which, when executed by the processor, cause the processor to:
parse a bitstream to determine first syntax information corresponding to a vertex in a current group, wherein the first syntax information indicates whether a motion vector corresponding to at least one coordinate dimension for the vertex in the current group is inferred to be a preset value; and
determine motion-vector decoded information corresponding to the vertex in the current group based on the first syntax information.
